(19) United States
(12) Patent Application Publication
(10) Pub. No.: US 2022/0168712 A1
(43) Pub. Date: Jun. 2, 2022

(54) DENITRATION CATALYST AND METHOD FOR MANUFACTURING SAME

(71) Applicants: THE CHUGOKU ELECTRIC POWER CO., INC., Hiroshima-shi, Hiroshima (JP); TOKYO METROPOLITAN PUBLIC UNIVERSITY CORPORATION, Tokyo (JP)

(72) Inventors: Eiji KIYONAGA, Hiroshima-shi, Hiroshima (JP); Kazuhiro YOSHIDA, Hiroshima-shi, Hiroshima (JP); Keiichiro MORITA, Hiroshima-shi, Hiroshima (JP); Toru MURAYAMA, Tokyo (JP); Masatake HARUTA, Tokyo (JP); Shinichi HATA, Tokyo (JP); Yusuke INOMATA, Tokyo (JP)

(21) Appl. No.: 17/436,958

(22) PCT Filed: Mar. 5, 2020
(86) PCT No.: PCT/JP2020/009542

§ 371 Date: Sep. 7, 2021

(30) Foreign Application Priority Data
Mar. 7, 2019 (JP) PCT/JP2019/009201
Mar. 7, 2019 (JP) PCT/JP2019/009202

(51) Int. Cl. B01J 23/888; F01N 3/20; B01J 35/10; B01J 21/18

(52) U.S. Cl. CPC B01J 23/888; F01N 3/2066; F01N 2570/14; B01J 21/18; B01J 35/1014

(57) ABSTRACT

Provided is a catalyst which, when used in a selective catalytic reduction reaction in which ammonia serves as the reducing agent, further improves denitration efficiency at low temperatures compared to the prior art.

The denitration catalyst comprises vanadium oxide as a main component, and has a content of a second metal, in teams of oxide, of 1-40 wt %. The second metal is at least one type of metal element selected from the group consisting of Co, W, Mo, Nb, Ce, Sn, Ni, Fe, Cu, Zn, and Mn.

### TECHNICAL FIELD

The present invention relates to a denitration catalyst and a manufacturing method thereof.

In more detail, the present invention relates to a denitration catalyst used upon purifying exhaust gas produced by fuel combusting, and a manufacturing method thereof.

### BACKGROUND ART

As one of the pollutants emitted into air by the combustion of fuel, nitrogen oxides (NO, NO₂, NO₃, N₂O, N₂O₃, N₂O₄, N₂O₅) can be exemplified.

The nitrogen oxides induce acid rain, ozone layer depletion, photochemical smog, etc., and have a serious influence on the environment and human bodies; therefore, treatment thereof is an important problem.

As technology for removing the above-mentioned nitrogen oxides, the selective catalytic reduction reaction (NH₃—SCR) with ammonia (NH₃) as the reductant has been known.

As disclosed in Patent Document 1, a catalyst using titanium oxide as the carrier and supporting vanadium oxide is being widely used as the catalyst used in the selective catalytic reduction reaction.
Titanium oxide has low activity for sulfur oxides, and has high stability; therefore, it is best established as the carrier.

On the other hand, although vanadium oxide plays a main role in NH₃—SCR, since it oxidizes SO₂ to SO₃, it has not been able to support on the order of 1 wt % or more of vanadium oxide.

In addition, with conventional NH₃—SCR, since the catalyst made by supporting vanadium oxide on a titanium oxide carrier almost does not react at low temperature, it must be used at high temperatures such as 350 to 400° C.
However, in order to raise the degrees of freedom of design in devices and facilities realizing NH₃—SCR and make more efficient, the development of a catalyst exhibiting high nitrogen oxide reduction rate activity at low temperatures has been demanded.

Subsequently, the present inventors have found a denitration catalyst in which vanadium pentoxide is present in at least 43 wt %, having a BET specific surface area of at least 30 m²/g, and which can be used in denitration at 200° C. or lower (Patent Document 2).
Patent Document 1: Japanese Unexamined Patent Application, Publication No. 2004-275852
Patent Document 2: Japanese Patent No. 6093101

### DISCLOSURE OF THE INVENTION

### Problems to be Solved by the Invention

The present inventors, as a result of thorough research trying to achieve a further improvement of the above Patent Document 2, found a denitration catalyst exhibiting a more superior reduction rate activity of nitrogen oxides.

The present invention has an object of providing a catalyst having better denitration efficiency at low temperature compared to the conventional technology, upon the selective catalytic reduction reaction with ammonia as the reductant.

### Means for Solving the Problems

The present invention relates to a denitration catalyst including: vanadium oxide as a main component, and a second metal, in which content by oxide conversion of the second metal is at least 1 wt % and no more than 40 wt %, and the second metal is at least one selected from the group consisting of Co, W, Mo, Nb, Ce, Sn, Ni, Fe, Cu, Zn and Mn.

In addition, in the denitration catalyst, it is preferable for the second metal to be W.

In addition, in the denitration catalyst, it is preferable for the second metal to be W, and to further include Cu as the third metal.

In addition, it is preferable for the denitration catalyst to include an oxide of a composite metal of vanadium and the second metal.

In addition, the denitration catalyst is preferably used in denitration at 300° C. or lower.

In addition, it is preferable for the denitration catalyst to further contain carbon.

In addition, it is preferable for the carbon content to be at least 0.05 wt %.

In addition, a method for manufacturing the denitration catalyst according to the present invention preferably includes a step of firing a mixture of vanadate, chelate compound and a compound of the second metal.

In addition, in the method for manufacturing the denitration catalyst according to the present invention, it is preferable for ethylene glycol to be further included in the mixture.

The step of firing is preferably a step of firing at a temperature of 270° C. or lower.

### Effects of the Invention

A denitration catalyst according to the present invention has better denitration efficiency at low temperature compared to the conventional technology, upon the selective catalytic reduction reaction with ammonia as the reductant.

### BRIEF DESCRIPTION OF THE DRAWINGS

FIG. 1 is a graph showing NO conversion rates of vanadium catalysts containing a second metal, and a vanadium catalyst not containing a second metal, according to each of the Examples;

FIG. 2 is a graph showing NO conversion rates of vanadium catalysts containing cobalt and a vanadium catalyst not containing cobalt, according to each of the Examples;

FIG. 3 is a graph showing powder XRD patterns of vanadium catalysts containing cobalt according to each of the Examples and Comparative Examples;

FIG. 4 is a graph showing Raman spectra of vanadium catalysts containing cobalt according to each of the Examples;

FIG. 5A is a graph showing XPS spectra in the V2p region of vanadium catalysts containing cobalt according to each of the Examples and Comparative Examples;

FIG. 5B is a graph showing XPS spectra in the Co2p region of vanadium catalysts containing cobalt according to each of the Examples and Comparative Examples;

FIG. 6 is a graph showing NO conversion rates of vanadium catalysts containing tungsten and a vanadium catalyst not containing tungsten, according to each of the Examples;

FIG. 7 is a graph showing powder XRD patterns of vanadium catalysts containing tungsten according to each of the Examples and Comparative Examples;

FIG. 8 is a graph showing a proportion of tungsten element in vanadium catalysts containing tungsten, according to each of the Examples and Comparative Examples;

FIG. 9 is a graph showing NO conversion rates of vanadium catalysts containing tungsten and a vanadium catalyst not containing tungsten, according to each of the Examples;

FIG. 10 is a graph showing powder XRD patterns of vanadium catalysts containing tungsten according to each of the Examples and Comparative Examples;

FIG. 11 is a graph showing a proportion of tungsten element in vanadium catalysts containing tungsten, according to each of the Examples and Comparative Examples;

FIG. 12 is a graph showing NO conversion rates of vanadium catalysts containing tungsten and a vanadium catalyst not containing tungsten, according to each of the Examples;

FIG. 13 is a graph showing NO conversion rates of vanadium catalysts according to Examples of the present invention;

FIG. 14 is a graph showing the specific surface area of vanadium catalysts, according to Examples and Comparative Examples of the present invention;

FIG. 15 is a graph showing the transition in NO conversion rates of vanadium catalysts, according to Examples and Comparative Examples of the present invention;

FIG. 16 is a graph showing NOx conversion rates under a dry atmosphere and under a 10% moisture atmosphere of vanadium catalysts, according to Examples and Comparative Examples of the present invention;

FIG. 17 shows NO conversion rates for every reaction temperature of vanadium catalysts, according to Examples and Comparative Examples of the present invention;

FIG. 18 is a TEM image of a vanadium catalyst according to an Example of the present invention;

FIG. 19 is a TEM image of a vanadium catalyst according to an Example of the present invention;

FIG. 20 is a TEM image of a vanadium catalyst according to an Example of the present invention;

FIG. 21 is a TEM image of a vanadium catalyst according to a Comparative Example of the present invention;

FIG. 22 is a graph showing NO conversion rates of vanadium catalysts containing niobium and a vanadium catalyst not containing niobium, according to Examples of the present invention;

FIG. 23 is a graph showing NO conversion rates of vanadium catalysts containing carbon and cobalt according to Examples of the present invention, and a vanadium catalyst according to a Comparative Example; and

FIG. 24 is a graph showing the NO conversion rates of vanadium catalysts according to Examples of the present invention.

### PREFERRED MODE FOR CARRYING OUT THE INVENTION

Hereinafter, embodiments of the present invention will be explained.

A denitration catalyst of the present invention is a denitration catalyst containing vanadium oxide as a main component, and containing a second metal, in which content by oxide conversion of the second metal is at least 1 wt % and no more than 40 wt %, and the second metal is at least one selected from the group consisting of Co, W, Mo, Nb, Ce, Sn, Ni, Fe, Cu, Zn and Mn.

Such a denitration catalyst can exhibit a high denitration effect even under a low temperature environment, compared to a denitration catalyst such as a vanadium/titanium catalyst which is conventionally used.

First, the denitration catalyst of the present invention establishes vanadium oxide as a main component.

This vanadium oxide includes vanadium oxide (II) (VO), vanadium trioxide (III) (V₂O₃), vanadium tetroxide (IV) (V₂O₄), and vanadium pentoxide (V) (V₂O₅), and the V element of vanadium pentoxide (V₂O₅) may assume the pentavalent, tetravalent, trivalent and divalent form in the denitration reaction.
It should be noted that this vanadium oxide is a main component of the denitration catalyst of the present invention, and may contain other substances within a range not inhibiting the effects of the present invention; however, it is preferably present in at least 50 wt % by vanadium pentoxide conversion, in the denitration catalyst of the present invention.
More preferably, vanadium oxide is preferably present in at least 60 wt % by vanadium pentoxide conversion, in the denitration catalyst of the present invention.

Secondly, the denitration catalyst of the present invention contains vanadium oxide as a main component, and a second metal; however, by containing by such a second metal, it is possible to exhibit high denitration effect even under a low temperature environment, compared to a denitration catalyst such as a vanadium/titanium catalyst which is conventionally used.

If impurities get into the denitration catalyst of the present invention, the crystal structure will not be continuous since an amorphous portion is produced in the denitration catalyst, and a high denitration effect is exhibited by the lines and planes in the crystal lattice distorting; however, it is assumed that higher denitration effect is exhibited as the second metal exists more abundantly as this impurity.

In the denitration catalyst of the present invention, by this second metal substituting the vanadium sites, this denitration catalyst either or both contains oxides of composite metal, or this denitration catalyst contains an oxide of the second metal.

In an embodiment of the present invention, in the selective catalytic reduction reaction at a reaction temperature of 200° C. or less using a denitration catalyst having a content of cobalt oxide of 1 wt % to 10 wt %, when calculating the content by oxide conversion of second metal, it exhibited a NO conversion rate of 79% to 100% in the case of no moisture coexistence, and exhibited a NO conversion rate of 38% to 90% in the case of moisture coexisting.

On the other hand, in the selective catalytic reduction reaction at a reaction temperature of 200° C. or less using a denitration catalyst having a content of cobalt oxide of 0 wt %, when calculating the content by oxide conversion of second metal, it only exhibited a NO conversion rate of 76% in the case of no moisture coexistence, and only exhibited a NO conversion rate of 32% in the case of moisture coexisting.

In addition, in the selective catalytic reduction reaction at a reaction temperature of 200° C. or less using a denitration catalyst having a content of tungsten oxide of 12 wt % to 38 wt %, when calculating the content by oxide conversion of second metal, it exhibited a NO conversion rate of 83% to 96% in the case of no moisture coexistence, and exhibited a NO conversion rate of 43% to 55% in the case of moisture coexisting.

On the other hand, in the selective catalytic reduction reaction at a reaction temperature of 200° C. or less using a denitration catalyst having a content of tungsten oxide of 0 wt %, when calculating the content by oxide conversion of second metal, it only exhibited a NO conversion rate of 76% in the case of no moisture coexistence, and only exhibited a NO conversion rate of 32% in the case of moisture coexisting.
In addition, in the selective catalytic reduction reaction at a reaction temperature of 200° C. or less using a denitration catalyst having a content of tungsten oxide of 62 wt % to 100 wt %, when calculating the content by oxide conversion of second metal, it only exhibited a NO conversion rate of 3% to 69% in the case of no moisture coexistence, and only exhibited a NO conversion rate of 0% to 29% in the case of moisture coexisting.

In addition, in the selective catalytic reduction reaction using a denitration catalyst having a content of niobium oxide of 2 wt % to 16 wt %, when calculating the content by oxide conversion of second metal, it exhibited a NO conversion rate of 90% to 97% in the case of no moisture coexistence, and exhibited a NO conversion rate of 50% to 73% in the case of moisture coexisting.

In addition, in the aforementioned disclosure, the denitration catalyst of the present invention establishes the content by oxide conversion of the second metal as at least 1 wt % and no more than 40 wt %; however, it is preferably set as at least 2 wt % and no more than 38 wt %.

In addition, the content by oxide conversion of the second metal is preferably set as at least 2 wt % and no more than 10 wt %.
In addition, the content by oxide conversion of the second metal is preferably set as at least 2 wt % and no more than 7 wt %.
In addition, the content by oxide conversion of the second metal is preferably set as at least 3 wt % and no more than 7 wt %.
In addition, the content by oxide conversion of the second metal is preferably set as at least 3 wt % and no more than 5 wt %.
In addition, the content by oxide conversion of the second metal is preferably set as at least 3 wt % and no more than 4 wt %.

Thirdly, the second metal is at least one selected from the group consisting of Co, W, Mo, Nb, Ce, Sn, Ni, Fe, Cu, Zn and Mn.

It is thereby possible to distort the crystal structure of vanadium oxide, and raise the Lewis acidity.
Above all, in the case of Co, Mo, Ce, Sn, Ni and Fe, it promotes the oxidation-reduction cycle of V₂O₅.
In addition, among these elements, Co is known to have strong oxidizability.
By W, Mo and Nb all functioning as solid acids, and providing an absorption site for ammonia, it becomes possible for ammonia to efficiently contact with NO and react.

In an embodiment of the present invention, in the selective catalytic reduction reaction at a reaction temperature of 200° C. or less using a denitration catalyst having a content of cobalt oxide of 3.1 wt %, when calculating the content by oxide conversion of second metal, it exhibited a NO conversion rate of 89.1% in the case of no moisture coexistence, and exhibited a NO conversion rate of 73.7% in the case of moisture coexisting.

In addition, in an embodiment of the present invention, in the selective catalytic reduction reaction at a reaction temperature of 200° C. or less using a denitration catalyst having a content of tungsten oxide of 8.4 wt %, when calculating the content by oxide conversion of second metal, it exhibited a NO conversion rate of 100% in the case of no moisture coexistence, and exhibited a NO conversion rate of 92.2% in the case of moisture coexisting.
In addition, in an embodiment of the present invention, in the selective catalytic reduction reaction at a reaction temperature of 200° C. or less using a denitration catalyst having a content of molybdenum oxide of 5.4 wt %, when calculating the content by oxide conversion of second metal, it exhibited a NO conversion rate of 91.2% in the case of no moisture coexistence, and exhibited a NO conversion rate of 71.3% in the case of moisture coexisting.
In addition, in an embodiment of the present invention, in the selective catalytic reduction reaction at a reaction temperature of 200° C. or less using a denitration catalyst having a content of niobium oxide of 5.0 wt %, when calculating the content by oxide conversion of second metal, it exhibited a NO conversion rate of 96.2% in the case of no moisture coexistence, and exhibited a NO conversion rate of 68.8% in the case of moisture coexisting.
In addition, in an embodiment of the present invention, in the selective catalytic reduction reaction at a reaction temperature of 200° C. or less using a denitration catalyst having a content of iron oxide of 3.1 wt %, when calculating the content by oxide conversion of second metal, it exhibited a NO conversion rate of 80.8% in the case of no moisture coexistence, and exhibited a NO conversion rate of 55.1% in the case of moisture coexisting.
In addition, in an embodiment of the present invention, in the selective catalytic reduction reaction at a reaction temperature of 200° C. or less using a denitration catalyst having a content of nickel oxide of 2.9 wt %, when calculating the content by oxide conversion of second metal, it exhibited a NO conversion rate of 80.5% in the case of no moisture coexistence, and exhibited a NO conversion rate of 70.1% in the case of moisture coexisting.
In addition, in an embodiment of the present invention, in the selective catalytic reduction reaction at a reaction temperature of 200° C. or less using a denitration catalyst having a content of copper oxide of 3.0 wt %, when calculating the content by oxide conversion of second metal, it exhibited a NO conversion rate of 98.8% in the case of no moisture coexistence, and exhibited a NO conversion rate of 81.0% in the case of moisture coexisting.
In addition, in an embodiment of the present invention, in the selective catalytic reduction reaction at a reaction temperature of 200° C. or less using a denitration catalyst having a content of zinc oxide of 3.1 wt %, when calculating the content by oxide conversion of second metal, it exhibited a NO conversion rate of 85.8% in the case of no moisture coexistence, and exhibited a NO conversion rate of 65.4% in the case of moisture coexisting.
In addition, in an embodiment of the present invention, in the selective catalytic reduction reaction at a reaction temperature of 200° C. or less using a denitration catalyst having a content of tin oxide of 5.6 wt %, when calculating the content by oxide conversion of second metal, it exhibited a NO conversion rate of 82.6% in the case of no moisture coexistence, and exhibited a NO conversion rate of 62.4% in the case of moisture coexisting.
In addition, in an embodiment of the present invention, in the selective catalytic reduction reaction at a reaction temperature of 200° C. or less using a denitration catalyst having a content of cerium oxide of 6.4 wt %, when calculating the content by oxide conversion of second metal, it exhibited a NO conversion rate of 82.1% in the case of no moisture coexistence, and exhibited a NO conversion rate of 71.7% in the case of moisture coexisting.
In addition, in an embodiment of the present invention, in the selective catalytic reduction reaction at a reaction temperature of 200° C. or less using a denitration catalyst having a content of manganese dioxide of 3.3 wt %, when calculating the content by oxide conversion of second metal, it exhibited a NO conversion rate of 86.0% in the case of no moisture coexistence, and exhibited a NO conversion rate of 66.0% in the case of moisture coexisting.
On the other hand, in the selective catalytic reduction reaction at a reaction temperature of 200° C. or less using a denitration catalyst not containing a second metal, it only exhibited a NO conversion rate of 82.3% in the case of no moisture coexistence, and exhibited a NO conversion rate of 47.2% in the case of moisture coexisting.

In addition, in the denitration catalyst of the present invention, the second metal is preferably W.

Although a repeat of the above, in the embodiment of the present invention, in the selective catalytic reduction reaction at a reaction temperature of 200° C. or less using a denitration catalyst having a content of tungsten oxide of 8.4 wt %, when calculating the content by oxide conversion of second metal, it exhibited a NO conversion rate of 100% in the case of no moisture coexistence, and exhibited a NO conversion rate of 92.2% in the case of moisture coexisting.

On the other hand, in the selective catalytic reduction reaction at a reaction temperature of 200° C. or less using a denitration catalyst not containing a second metal, it only exhibited a NO conversion rate of 82.3% in the case of no moisture coexistence, and exhibited a NO conversion rate of 47.2% in the case of moisture coexisting.

In addition, in the denitration catalyst of the present invention, it is preferable for the second metal to be W, and to further contain Cu as a third metal.

In the embodiment of the present invention, in the selective catalytic reduction reaction at a reaction temperature of 200° C. or less using a denitration catalyst having a content of WO₃ of 8.4 wt % and a content of CuO of 3.0 wt %, when calculating the content by oxide conversion of the second and third metals, it exhibited a NO conversion rate of 89.2% in the case of no moisture coexistence, and exhibited a NO conversion rate of 79.2% in the case of moisture coexisting.
It should be noted that the upper limit for the content of CuO is 13 wt %.

In addition, the denitration catalyst of the present invention desirably contains oxides of composite metal of vanadium and the second metal.

In the embodiment of the present invention, in the selective catalytic reduction reaction at a reaction temperature of 150° C. using a denitration catalyst produced using metatungstic acid as a precursor, when using a denitration catalyst having a total weight ratio of WO₃ of 2.5 wt % to 11.8 wt % in the case of oxide converting the content ratio of W, it exhibited a NO conversion rate of 85% to 100%% in the case of no moisture coexistence, and exhibited a NO conversion rate of 62% to 92% in the case of moisture coexisting.

On the other hand, although a repeat of the above, in the selective catalytic reduction reaction at a reaction temperature of 200° C. or less using a denitration catalyst not containing a second metal, it only exhibited a NO conversion rate of 82.3% in the case of no moisture coexistence, and exhibited a NO conversion rate of 47.2% in the case of moisture coexisting.
From the TEM image of this denitration catalyst produced using metatungstic acid as a precursor, it was shown that the V site in the crystal lattice of vanadium pentoxide is substituted by W, i.e. V is isolated in atomic form, and this denitration catalyst contains oxides of a composite metal of V and W.

In addition, the denitration catalyst of the present invention is preferably used in denitration at 300° C. or lower.

This is because the firing temperature of the denitration catalyst of the present invention is 300° C.
On the other hand, in the Examples described later, the denitration catalyst of the present invention exhibits high denitration effect in the selective catalytic reduction reaction at a reaction temperature of 200° C. or less; therefore, the denitration catalyst of the present invention can be used in denitration at 200° C. or less.
Since oxidation from SO₂ to SO₃ does not occur at 200° C. or lower, oxidation of SO₂ to SO₃ is not accompanying upon the selective catalytic reduction reaction at 200° C. or lower, as in the knowledge obtained by Patent Document 2 described above.

In addition, in the aforementioned description, the denitration catalyst of the present invention is preferably used in denitration at 300° C. or lower; however, it may preferably be used in denitration at 200° C. or lower, or may be more preferably used in denitration at a reaction temperature of 100 to 200° C.

More preferably, it may be used in denitration at a reaction temperature of 160 to 200° C.
Alternatively, it may be used in denitration at a reaction temperature of 80 to 150° C.

In addition, the denitration catalyst of the present invention more preferably contains carbon.

Above all, the carbon content is preferably at least 0.05 wt % and no more than 3.21 wt %.
It should be noted that the carbon content may preferably be at least 0.07 wt % to no more than 3.21 wt %.
More preferably, the carbon content may be at least 0.11 wt % to no more than 3.21 wt %.
More preferably, the carbon content may be at least 0.12 wt % to no more than 3.21 wt %.
More preferably, the carbon content may be at least 0.14 wt % to no more than 3.21 wt %.
More preferably, the carbon content may be at least 0.16 wt % to no more than 3.21 wt %.
More preferably, the carbon content may be at least 0.17 wt % to no more than 3.21 wt %.
More preferably, the carbon content may be at least 0.70 wt % to no more than 3.21 wt %.
By containing carbon, it is possible to exhibit high denitration effect even in a low temperature environment, compared to a denitration catalyst such as a vanadium/titanium catalyst which is conventionally used.
If impurities get into the denitration catalyst of the present invention, the crystal structure will not be continuous since the amorphous portion is produced in the denitration catalyst, a high denitration effect is exhibited by the lines and planes in the crystal lattice distorting; however, it is assumed that higher denitration effect is exhibited by carbon existing as this impurity.

Hereinafter, a method is shown for preparing a denitration catalyst with vanadium oxide as a main component and containing a second metal, in which the content by oxide conversion of the second metal is at least 1 wt % and no more than 40 wt %, and the second metal is at least one selected from the group consisting of Co, W, Mo, Nb, Ce, Sn, Ni, Fe, Cu, Zn and Mn.

The preparation method of the above-mentioned denitration catalyst includes a step of firing a mixture of vanadate, chelate compound and a compound of the second metal.

As the vanadate, for example, ammonium vanadate, magnesium vanadate, strontium vanadate, barium vanadate, zinc vanadate, lead vanadate, lithium vanadate, etc. may be used.
In addition, as the chelate compound, one having a plurality of carboxyl groups such as oxalic acid and citric acid, one having a plurality of amino groups such as acetylacetone and ethylenediamine, one having a plurality of hydroxyl groups such as ethylene glycol, etc. may be used.
In addition, the compound of the second metal may be a chelate complex, hydrate, ammonium compound, or phosphate compound.
The chelate complex may be a complex of oxalic acid, citric acid or the like, for example.
The hydrate may be (NH₄)₁₀W₁₂O₄₁.5H₂O or H₃PW₁₂O₄₀.nH₂O, for example.
The ammonium compound may be (NH₄)₁₀W₁₂O₄₁.5H₂O, for example.
The phosphate compound may be H₃PW₁₂O₄₀.nH₂O, for example.

In addition, it is preferable for ethylene glycol to be further contained in the above-mentioned mixture.

The denitration catalyst produced by these methods can exhibit high denitration effect under a low temperature atmosphere, compared to a denitration catalyst such as a vanadium/titanium catalyst which is conventionally used.

If impurities get into the denitration catalyst of the present invention, the crystal structure will not be continuous since the amorphous portion is produced in the denitration catalyst, a high denitration effect is exhibited by the lines and planes in the crystal lattice distorting; however, it is assumed that higher denitration effect is exhibited as the carbon exists more abundantly as this impurities.

In the embodiment of the present invention, the denitration catalyst produced by the method firing a mixture of ammonium vanadate, oxalic acid and an oxalic acid complex of the second metal exhibited a NO conversion rate of 80.5% to 100% in the case of no moisture coexistence, and exhibited a NO conversion rate of 55.1% to 92.2% in the case of moisture coexisting.

In addition, the denitration catalyst produced by a method in which ethylene glycol is further included in the above-mentioned mixture exhibited a NO conversion rate of 100% in the case of no moisture coexistence, and exhibited a NO conversion rate of 89% in the case of moisture coexisting.
On the other hand, as the denitration catalyst produced by a method not including such a step, for example, the denitration catalyst produced by a method mixing ammonium vanadate and oxalic acid, but firing without mixing an oxide of the second metal, only exhibited a NO conversion rate of 82.3% in the case of no moisture coexistence, and exhibited a NO conversion rate of 47.2% in the case of moisture coexisting.

In addition, the above-mentioned firing is preferably performed at a temperature no higher than 270° C.

During production of the denitration catalyst according to the present embodiment, by firing at a temperature no higher than 270° C., which is a low temperature compared to the usual 300° C., the structure of the vanadium pentoxide crystals contained in this denitration catalyst is locally distorted, and can exhibit a high denitration effect; however, it is assumed that, above all, high denitration effect is exhibited by sites appearing at which an oxygen atom is deficient in the crystal structure of vanadium pentoxide.
It should be noted that “sites at which an oxygen atom is deficient” is also designated as “oxygen defect site”.

The denitration catalyst prepared in this way is a denitration catalyst establishing vanadium oxide as a main component, in which content of oxide of the second metal is at least 1 wt % and no more than 40 wt %, and the second metal is at least one metallic element selected from the group consisting of Co, W, Mo, Nb, Ce, Sn, Ni, Fe, Cu, Zn and Mn.

According to the denitration catalyst related to the above embodiment, the following effects are exerted.

(1) As mentioned above, the denitration catalyst according to the present embodiment is a denitration catalyst establishing vanadium oxide as a main component, and containing a second metal, in which content by oxide conversion of the second metal is at least 1 wt % and no more than 40 wt %, and the second metal is at least one selected from the group consisting of Co, W, Mo, Nb, Ce, Sn, Ni, Fe, CU, Zn and Mn.

By using this denitration catalyst, upon selective catalytic reduction reaction under a reaction temperature of 200° C. or less with ammonia as a reductant, it is possible to exhibit an effect whereby the denitration efficiency is even higher at low temperature, compared to the conventional technology.
In addition, absorption of NO tends to occur, and this denitration catalyst can exhibit a higher NO conversion rate.

(2) As mentioned above, in the denitration catalyst according to the present embodiment, the second metal was defined as being W.

By using this denitration catalyst, it is possible to further exhibit an effect whereby the denitration efficiency at low temperature is even higher compared to the conventional technology.
In addition, the absorption of NO tends to occur, and this denitration catalyst can further exhibit an even higher NO conversion rate.

(3) As mentioned above, in the denitration catalyst according to the present embodiment, the second metal is W, and the denitration catalyst further contains Cu as a third metal.

By using this denitration catalyst, it is possible to further exhibit an effect whereby the denitration efficiency at low temperature is even higher compared to the conventional technology.
In addition, absorption of NO tends to occur even more, and NO further oxidizes to NO₂, whereby this denitration catalyst can further exhibit a higher NO conversion rate by a catalytic reaction mechanism under NO and NO₂ coexistence.

(4) As mentioned above, the denitration catalyst according to the present embodiment contains an oxide of composite metal of vanadium and the second metal.

By using this denitration catalyst, it is possible to further exhibit an effect whereby the denitration efficiency at low temperature is even higher compared to the conventional technology.
In addition, the absorption of NO tends to occur, whereby this denitration catalyst can further exhibit an even higher NO conversion rate.

(5) As mentioned above, the denitration catalyst according to the present embodiment is preferably used in denitration at 300° C. or lower. In the selective catalytic reduction reaction at a reaction temperature of 200° C. or less using the denitration catalyst according to the above embodiment, a high denitration effect is thereby brought about, without oxidizing SO₂.

(6) As mentioned above, the denitration catalyst according to the present embodiment preferably further contains carbon.

The denitration catalyst according to the present embodiment can thereby exhibit an even higher NO conversion rate, under conditions not coexisting with moisture.

(7) As mentioned above, the carbon content is preferably at least 0.05 wt %.

The denitration catalyst according to the present embodiment can thereby exhibit a higher NO conversion rate, under conditions not coexisting with moisture.

(8) As mentioned above, the method of manufacturing the denitration catalyst according to the present embodiment preferably includes a step of firing a mixture of vanadate, chelate compound and compound of the second metal.

By the second metal being contained in the denitration catalyst according to the present embodiment, the denitration effect improves in the selective catalytic reduction reaction at a reaction temperature of 200° C. or less using the denitration catalyst according to the above embodiment.

(9) Ethylene glycol is preferably further contained in the above-mentioned mixture.

Carbon and the second metal are contained in the denitration catalyst according to the present embodiment, and the denitration effect thereby improves in the selective catalyst reduction reaction at the reaction temperature of 200° C. or less using the denitration catalyst according to the present embodiment.

(10) The step of firing in the above-mentioned method for manufacturing is preferably a step of firing at a temperature no higher than 270° C.

The structure of the vanadium pentoxide crystals contained in the denitration catalyst is locally distorted, and it is thereby possible to exhibit a high denitration effect.

It should be noted that the present invention is not to be limited to the above embodiment, and that modifications, improvements, etc. within a scope that can achieve the object of the present invention are also encompassed by the present invention.

### EXAMPLES

Hereinafter, Examples of the present invention will be specifically explained together with Comparative Examples.

It should be noted that the present invention is not to be limited by these Examples.

1 Vanadium Catalyst Containing Various Metals as Second Metal

1.1 Each Example and Comparative Example

### Example 1

A precursor complex was synthesized by dissolving 4.96 g (42.4 mmol) of ammonium vanadate (NH₄VO₃) and 11.5 g (127.6 mmol) of oxalic acid ((COOH)₂) in pure water.

To this precursor complex, oxalic acid complex of cobalt (Co), which is the second metal, was added, so that the cobalt (Co) becomes 3.5 mol % by metallic atom conversion, i.e. Co₃O₄ becomes 3.1 wt % by metal oxide conversion.
By firing the obtained vanadium-dissimilar metal complex mixture twice for 4 hours at a temperature of 300° C. by an electric furnace, a denitration catalyst of vanadium pentoxide (V₂O₅) containing cobalt (Co) was obtained.

### Example 2

A precursor complex was synthesized by dissolving 4.96 g (42.4 mmol) of ammonium vanadate (NH₄VO₃) and 11.5 g (127.6 mmol) of oxalic acid ((COOH)₂) in pure water.

To this precursor complex, oxalic acid complex of tungsten (W), which is the second metal, was added, so that the tungsten (W) becomes 3.5 mol % by metallic atom conversion, i.e. WO₃ becomes 8.4 wt % by metal oxide conversion.
By firing the obtained vanadium-dissimilar metal complex mixture twice for 4 hours at a temperature of 300° C. by an electric furnace, a denitration catalyst of vanadium pentoxide (V₂O₅) containing tungsten (W) was obtained.

### Example 3

A precursor complex was synthesized by dissolving 4.96 g (42.4 mmol) of ammonium vanadate (NH₄VO₃) and 11.5 g (127.6 mmol) of oxalic acid ((COOH)₂) in pure water.

To this precursor complex, oxalic acid complex of molybdenum (Mo), which is the second metal, was added, so that the molybdenum (Mo) becomes 3.5 mol % by metallic atom conversion, i.e. MoO₃ becomes 5.4 wt % by metal oxide conversion.
By firing the obtained vanadium-dissimilar metal complex mixture twice for 4 hours at a temperature of 300° C. by an electric furnace, a denitration catalyst of vanadium pentoxide (V₂O₅) containing molybdenum (Mo) was obtained.

### Example 4

A precursor complex was synthesized by dissolving 4.96 g (42.4 mmol) of ammonium vanadate (NH₄VO₃) and 11.5 g (127.6 mmol) of oxalic acid ((COOH)₂) in pure water.

To this precursor complex, oxalic acid complex of niobium (Nb), which is the second metal, was added, so that the niobium (Nb) becomes 3.5 mol % by metallic atom conversion, i.e. Nb₂O₅ becomes 5.0 wt % by metal oxide conversion.
By firing the obtained vanadium-dissimilar metal complex mixture twice for 4 hours at a temperature of 300° C. by an electric furnace, a denitration catalyst of vanadium pentoxide (V₂O₅) containing niobium (Nb) was obtained.

### Example 5

A precursor complex was synthesized by dissolving 4.96 g (42.4 mmol) of ammonium vanadate (NH₄VO₃) and 11.5 g (127.6 mmol) of oxalic acid ((COOH)₂) in pure water.

To this precursor complex, oxalic acid complex of iron (Fe), which is the second metal, was added, so that the iron (Fe) becomes 3.5 mol % by metallic atom conversion, i.e. Fe₂O₃ becomes 3.1 wt % by metal oxide conversion.
By firing the obtained vanadium-dissimilar metal complex mixture twice for 4 hours at a temperature of 300° C. by an electric furnace, a denitration catalyst of vanadium pentoxide (V₂O₅) containing iron (Fe) was obtained.

### Example 6

A precursor complex was synthesized by dissolving 4.96 g (42.4 mmol) of ammonium vanadate (NH₄VO₃) and 11.5 g (127.6 mmol) of oxalic acid ((COOH)₂) in pure water.

To this precursor complex, 0.113 g of nickel (Ni), which is the second metal, was added as nickel carbonate, so that the nickel (Ni) becomes 3.5 mol % by metallic atom conversion, i.e. NiO becomes 2.9 wt % by metal oxide conversion.
By firing the obtained vanadium-dissimilar metal complex mixture twice for 4 hours at a temperature of 300° C. by an electric furnace, a denitration catalyst of vanadium pentoxide (V₂O₅) containing nickel (Ni) was obtained.

### Example 7

A precursor complex was synthesized by dissolving 4.96 g (42.4 mmol) of ammonium vanadate (NH₄VO₃) and 11.5 g (127.6 mmol) of oxalic acid ((COOH)₂) in pure water.

To this precursor complex, oxalic acid complex of copper (Cu), which is the second metal, was added, so that the copper (Cu) becomes 3.5 mol % by metallic atom conversion, i.e. CuO becomes 3.0 wt % by metal oxide conversion.
By firing the obtained vanadium-dissimilar metal complex mixture twice for 4 hours at a temperature of 300° C. by an electric furnace, a denitration catalyst of vanadium pentoxide (V₂O₅) containing copper (Cu) was obtained.

### Example 8

A precursor complex was synthesized by dissolving 4.96 g (42.4 mmol) of ammonium vanadate (NH₄VO₃) and 11.5 g (127.6 mmol) of oxalic acid ((COOH)₂) in pure water.

To this precursor complex, oxalic acid complex of zinc (Zn), which is the second metal, was added, so that the zinc (Zn) becomes 3.5 mol % by metallic atom conversion, i.e. ZnO becomes 3.1 wt % by metal oxide conversion.
By firing the obtained vanadium-dissimilar metal complex mixture twice for 4 hours at a temperature of 300° C. by an electric furnace, a denitration catalyst of vanadium pentoxide (V₂O₅) containing zinc (Zn) was obtained.

### Example 9

A precursor complex was synthesized by dissolving 4.96 g (42.4 mmol) of ammonium vanadate (NH₄VO₃) and 11.5 g (127.6 mmol) of oxalic acid ((COOH)₂) in pure water.

To this precursor complex, oxalic acid complex of tin (Sn), which is the second metal, was added, so that the tin (Sn) becomes 3.5 mol % by metallic atom conversion, i.e. SnO₂ becomes 5.6 wt % by metal oxide conversion.
By firing the obtained vanadium-dissimilar metal complex mixture twice for 4 hours at a temperature of 300° C. by an electric furnace, a denitration catalyst of vanadium pentoxide (V₂O₅) containing tin (Sn) was obtained.

### Example 10

A precursor complex was synthesized by dissolving 4.96 g (42.4 mmol) of ammonium vanadate (NH₄VO₃) and 11.5 g (127.6 mmol) of oxalic acid ((COOH)₂) in pure water.

To this precursor complex, oxalic acid complex of cerium (Ce), which is the second metal, was added, so that the cerium (Ce) becomes 3.5 mol % by metallic atom conversion, i.e. CeO₂ becomes 6.4 wt % by metal oxide conversion.
By firing the obtained vanadium-dissimilar metal complex mixture twice for 4 hours at a temperature of 300° C. by an electric furnace, a denitration catalyst of vanadium pentoxide (V₂O₅) containing cerium (Ce) was obtained.

### Example 11

A precursor complex was synthesized by dissolving 4.96 g (42.4 mmol) of ammonium vanadate (NH₄VO₃) and 11.5 g (127.6 mmol) of oxalic acid ((COOH)₂) in pure water.

To this precursor complex, oxalic acid complex of manganese (Mn), which is the second metal, was added, so that the manganese (Mn) becomes 3.5 mol % by metallic atom conversion, i.e. MnO₂ becomes 3.3 wt % by metal oxide conversion.
By firing the obtained vanadium-dissimilar metal complex mixture twice for 4 hours at a temperature of 300° C. by an electric furnace, a denitration catalyst of vanadium pentoxide (V₂O₅) containing manganese (Mn) was obtained.

### Comparative Example 1

A precursor complex was synthesized by dissolving 4.96 g (42.4 mmol) of ammonium vanadate (NH₄VO₃) and 11.5 g (127.6 mmol) of oxalic acid ((COOH)₂).

By firing this precursor complex twice for 4 hours at a temperature of 300° C. by an electric furnace, a denitration catalyst of vanadium pentoxide (V₂O₅) not containing the second metal was obtained.

### 1.2 Evaluation

### 1.2.1 NO Conversion Rate

Under the conditions of Table 1 below, the NH₃—SCR reaction was conducted using a fixed bed flow-type reactor at a reaction temperature of 150° C.
In the gas passing through the catalyst layer, NO was analyzed by a Jasco FT-IR-4700.

TABLE 1
NH₃-SCR measurement conditions

| | |
|---|---|
| Reaction temperature | 150° C. |
| Catalyst amount | 0.375 g |
| Gas flow rate | 250 ml min⁻¹ |
| | NO: 250 ppm, NH₃: 250 ppm, O₂: 4 vol % |
| | in Ar, 10% H₂O (steam atmosphere) |
| Space velocity | 40,000 mL h⁻¹g_{cat}⁻¹ |

In addition, the NO conversion rate was calculated by Formula (1) noted below.

It should be noted that No is the NO concentration at the reaction tube inlet, and NOₒᵤₜ is the NO concentration of the reaction tube outlet.

$$\begin{matrix}Formula 1 & \\ NO conversion rate [ \% ] = \frac{{NO}_{in} - {NO}_{out}}{{NO}_{in}} \times 100 & ( Formula 1 )\end{matrix}$$

### (Measurement Results)

Table 2 shows the NO conversion rates of each vanadium pentoxide catalyst for both a case of moisture not coexisting and the case of a 10% steam atmosphere.

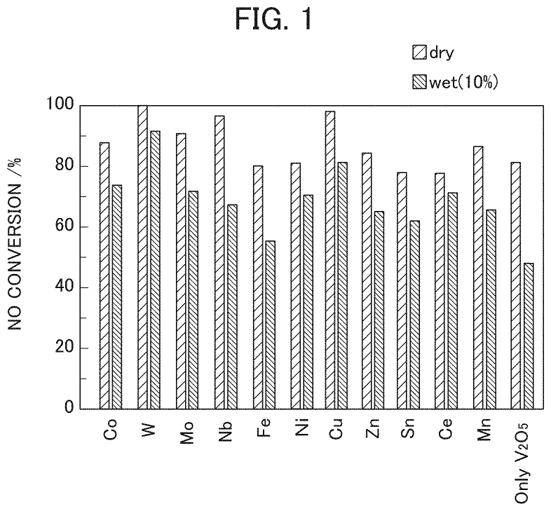

FIG. 1 is a plot graphing this Table 2.

TABLE 2
NOx conversion rate of vanadium pentoxide catalyst

| | | NO conversion rate/% | |
|---|---|---|---|
| Sample | | dry | wet (10%) |
| Example 1 | (Co) | 89.1 | 73.7 |
| Example 2 | (W) | 100 | 92.2 |
| Example 3 | (Mo) | 91.2 | 71.3 |
| Example 4 | (Nb) | 96.2 | 68.8 |
| Example 5 | (Fe) | 80.8 | 55.1 |
| Example 6 | (Ni) | 80.5 | 70.1 |
| Example 7 | (Cu) | 98.8 | 81.0 |
| Example 8 | (Zn) | 85.8 | 65.4 |
| Example 9 | (Sn) | 82.6 | 62.4 |
| Example 10 | (Ce) | 82.1 | 71.7 |
| Example 11 | (Mn) | 86.0 | 66.0 |
| Comparative | (Only V₂O₅) | 82.3 | 47.2 |
| Example 1 | | | |

In the case of the 10% steam atmosphere, the denitration catalyst of the Examples generally exhibited higher NO conversion rate than the denitration catalyst of the Comparative Examples in both the case of moisture not coexisting and the case of coexistence with moisture. Above all, the denitration catalyst made by adding cobalt, tungsten, molybdenum, niobium, copper, zinc or manganese to ammonium vanadate exhibited a high NO conversion rate.

Thereamong, Example 2 (adding tungsten) exhibited the highest NO conversion rate, in both the case of moisture not coexisting and the case of moisture coexisting.

In addition, under the conditions of Table 3 below, the NH₃—SCR reaction was conducted using a fixed bed flow-type reactor at a reaction temperature of 150° C.

In the gas passing through the catalyst layer, NO was analyzed by a Jasco FT-IR-4700.

TABLE 3
NH₃-SCR measurement conditions

| | |
|---|---|
| Reaction temperature | 150° C. |
| Catalyst amount | 0.375 g |
| Gas flow rate | 250 ml min⁻¹ |
| | NO: 250 ppm, NH₃: 250 ppm, O₂: 4 vol % |
| | in Ar, 2.3% H₂O (steam atmosphere) |
| Space velocity | 40,000 mL h⁻¹g_{cat}⁻¹ |

### (Measurement Results)

Table 4 shows the NO conversion rates of each vanadium pentoxide catalyst for both a case of moisture not coexisting and the case of a 2.3% steam atmosphere.

TABLE 4
NOx conversion rate of vanadium pentoxide catalyst

| | | NO conversion rate/% | |
|---|---|---|---|
| Sample | | dry | wet (2.3%) |
| Example 1 | (Co) | 94.6 | 69.4 |
| Example 2 | (W) | 92.0 | 64.0 |
| Example 3 | (Mo) | 97.0 | 62.0 |
| Example 4 | (Nb) | 96.7 | 61.7 |
| Example 5 | (Ce) | 89.8 | 52.9 |
| Example 6 | (Sn) | 88.1 | 45.5 |
| Example 7 | (Fe) | 74.5 | 33.9 |
| Comparative | (None) | 75.5 | 32.0 |
| Example 1 | | | |

In both a case of moisture not coexisting and the case of a 2.3% steam atmosphere, the denitration catalysts of the Examples generally exhibited a higher NO conversion rate than the denitration catalysts of the Comparative Examples.

Above all, the denitration catalyst made by adding cobalt, tungsten, molybdenum, or niobium, to ammonium vanadate exhibited a high NO conversion rate.
Thereamong, for the case of moisture not coexisting, Example 3 (adding molybdenum) exhibited the highest NO conversion rate, and for the case of moisture coexisting, Example 1 (adding cobalt) exhibited the highest NO conversion rate.

### 2 Vanadium Catalyst Containing Cobalt as Second Metal

### 2.1 Each Example

As mentioned above, for the vanadium catalysts of Examples 1 to 11, in the case of moisture coexisting, since Example 1 (adding cobalt) exhibited relative high NO conversion rate, the vanadium catalyst according to each of the Examples below were produced by varying the additive amount of cobalt.

### Example 12

A precursor complex was synthesized by dissolving ammonium vanadate (NH₄VO₃) and oxalic acid ((COOH)₂) in pure water.

To this precursor complex, oxalic acid complex of cobalt (Co), which is the second metal, was added, so that Co₃O₄ becomes 1 wt % by metal oxide conversion.
By firing the obtained vanadium-cobalt complex mixture twice for 4 hours at a temperature of 300° C. by an electric furnace, a denitration catalyst of vanadium pentoxide (V₂O₅) containing cobalt (Co) was obtained.

### Example 13

A precursor complex was synthesized by dissolving ammonium vanadate (NH₄VO₃) and oxalic acid ((COOH)₂) in pure water.

To this precursor complex, oxalic acid complex of cobalt (Co), which is the second metal, was added, so that Co₃O₄ becomes 3 wt % by metal oxide conversion.
By firing the obtained vanadium-cobalt complex mixture twice for 4 hours at a temperature of 300° C. by an electric furnace, a denitration catalyst of vanadium pentoxide (V₂O₅) containing cobalt (Co) was obtained.

### Example 14

A precursor complex was synthesized by dissolving ammonium vanadate (NH₄VO₃) and oxalic acid ((COOH)₂) in pure water.

To this precursor complex, oxalic acid complex of cobalt (Co), which is the second metal, was added, so that Co₃O₄ becomes 5 wt % by metal oxide conversion.
By firing the obtained vanadium-cobalt complex mixture twice for 4 hours at a temperature of 300° C. by an electric furnace, a denitration catalyst of vanadium pentoxide (V₂O₅) containing cobalt (Co) was obtained.

### Example 15

A precursor complex was synthesized by dissolving ammonium vanadate (NH₄VO₃) and oxalic acid ((COOH)₂) in pure water.

To this precursor complex, oxalic acid complex of cobalt (Co), which is the second metal, was added, so that Co₃O₄ becomes 6 wt % by metal oxide conversion.
By firing the obtained vanadium-cobalt complex mixture twice for 4 hours at a temperature of 300° C. by an electric furnace, a denitration catalyst of vanadium pentoxide (V₂O₅) containing cobalt (Co) was obtained.

### Example 16

A precursor complex was synthesized by dissolving ammonium vanadate (NH₄VO₃) and oxalic acid ((COOH)₂) in pure water.

To this precursor complex, oxalic acid complex of cobalt (Co), which is the second metal, was added, so that Co₃O₄ becomes 7 wt % by metal oxide conversion.
By firing the obtained vanadium-cobalt complex mixture twice for 4 hours at a temperature of 300° C. by an electric furnace, a denitration catalyst of vanadium pentoxide (V₂O₅) containing cobalt (Co) was obtained.

### Example 17

A precursor complex was synthesized by dissolving ammonium vanadate (NH₄VO₃) and oxalic acid ((COOH)₂) in pure water.

To this precursor complex, oxalic acid complex of cobalt (Co), which is the second metal, was added, so that Co₃O₄ becomes 8 wt % by metal oxide conversion.
By firing the obtained vanadium-cobalt complex mixture twice for 4 hours at a temperature of 300° C. by an electric furnace, a denitration catalyst of vanadium pentoxide (V₂O₅) containing cobalt (Co) was obtained.

### Example 18

A precursor complex was synthesized by dissolving ammonium vanadate (NH₄VO₃) and oxalic acid ((COOH)₂) in pure water.

To this precursor complex, oxalic acid complex of cobalt (Co), which is the second metal, was added, so that Co₃O₄ becomes 10 wt % by metal oxide conversion.
By firing the obtained vanadium-cobalt complex mixture twice for 4 hours at a temperature of 300° C. by an electric furnace, a denitration catalyst of vanadium pentoxide (V₂O₅) containing cobalt (Co) was obtained.

It should be noted that Table 5 below shows the charging amount of precursor during cobalt introduction in Examples 12 to 18.

TABLE 5
Charging amount of precursor during cobalt introduction

| | Co₃O₄ | Co complex/ | Co complex/ | NH₄VO₃/ | NH₄VO₃/ | Oxalic acid/ | Oxalic acid/ |
|---|---|---|---|---|---|---|---|
| | wt % | mmol | g | mmol | g | mmol | g |
| Comparative | 0 | 0 | 0 | 43.9 | 5.13 | 131.7 | 11.86 |
| Example 1 | | | | | | | |
| Example 12 | 1 | 0.48 | 0.23 | 43.4 | 5.07 | 130.26 | 11.73 |
| Example 13 | 3 | 1.52 | 0.74 | 42.4 | 4.96 | 127.14 | 11.45 |
| Example 14 | 5 | 2.52 | 1.23 | 41.4 | 4.84 | 124.14 | 11.18 |
| Example 15 | 6 | 2.88 | 1.4 | 41 | 4.8 | 123.07 | 11.08 |
| Example 16 | 7 | 3.4 | 1.63 | 40.5 | 4.74 | 121.63 | 10.95 |
| Example 17 | 8 | 3.83 | 1.87 | 40.1 | 4.69 | 120.19 | 10.82 |
| Example 18 | 10 | 5.75 | 2.33 | 39.1 | 4.57 | 117.31 | 10.56 |

### 2.2 Evaluation

### 2.2.1 NO Conversion Rate

### (Measurement Method)

Under the conditions of the above Table 3, the NH₃—SCR reaction was conducted using a fixed bed flow-type reactor at a reaction temperature of 150° C.
In the gas passing through the catalyst layer, NO was analyzed by a Jasco FT-IR-4700.
In addition, the NO conversion rate was calculated by Formula (1) above.

### (Measurement Results)

Table 6 shows the NO conversion rates for both the case of moisture not coexisting and the case under coexistence of moisture of each vanadium oxide catalyst.

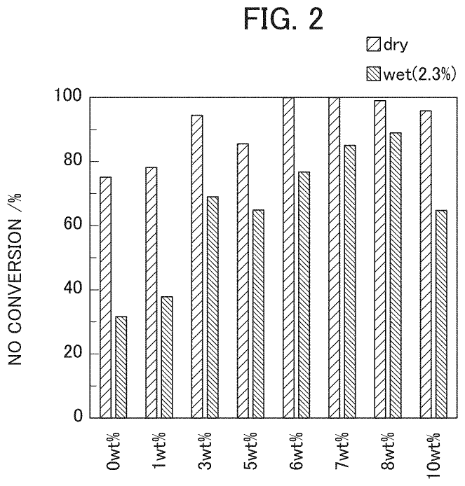

FIG. 2 is a plot graphing this Table 6.

TABLE 6
NOx conversion rate of vanadium pentoxide catalyst

| | | NO conversion rate/% | |
|---|---|---|---|
| Sample | | dry | wet (2.3%) |
| Comparative | (None) | 76 | 32 |
| Example 1 | | | |
| Example 12 | (1 wt %) | 79 | 38 |
| Example 13 | (3 wt %) | 94 | 69 |
| Example 14 | (5 wt %) | 95 | 65 |
| Example 15 | (6 wt %) | 100 | 77 |
| Example 16 | (7 wt %) | 100 | 86 |
| Example 17 | (8 wt %) | 99 | 90 |
| Example 18 | (10 wt %) | 96 | 65 |

In both the case of moisture not coexisting and the case under coexistence of moisture, the denitration catalyst of the Examples shows higher NO conversion rate than the denitration catalyst of the Comparative Example.

Above all, in the case of moisture not coexisting, Example 15 (6 wt %) and Example 16 (7 wt %) showed the highest NO conversion rates, and in the case of moisture coexisting, Example 17 (8 wt %) showed the highest NO conversion rate.

### 2.2.2 Powder X-ray Diffraction

### (Analysis Method)

As power X-ray diffraction, measurement was performed using Cu-Kα by a Rigaku Smart Lab.

### (Analysis Results)

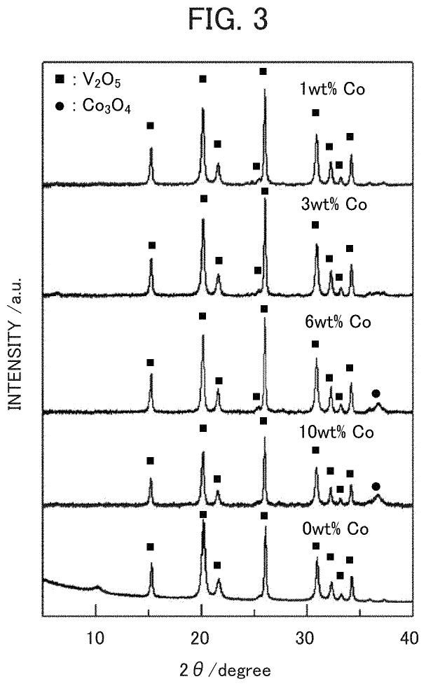

FIG. 3 shows the powder XRD (X-Ray Diffraction) patterns of Example 12 (1 wt %), Example 13 (3 wt %), Example 15 (6 wt %), Example 18 (10 wt %) and Comparative Example 1 (None: 0 wt %).

It showed that, when V₂O₅ which is the stabilized phase exists as the main component, and raising the added amount of Co, the Co₃O₄ phase also appeared.

### 2.2.3 Raman Spectrum

### (Measurement Method)

In order to analyze the crystal structure of each vanadium pentoxide catalyst, the Raman spectra was measured by Raman spectroscopy.

In more detail, a small amount of a sample of each catalyst was placed on a slide of glass, and the Raman spectra were measured by a Raman spectrometer.
As the measurement apparatus, an NRS-4100 Raman spectrophotometer manufactured by JASCO Corp. was used.

### (Measurement Results)

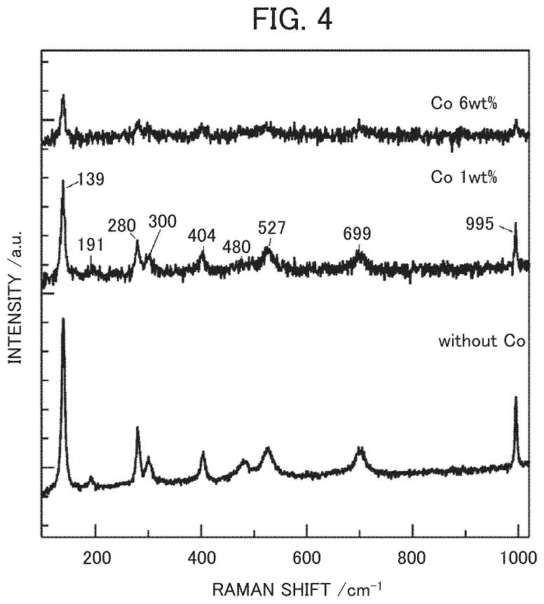

FIG. 4 shows the Raman spectra of each catalyst.

It is shown that, when raising the added amount of Co, the crystal structure of V₂O₅ collapses, and the pattern intensity weakens.

### 2.2.4 X-ray Photoelectron Spectrum (XPS) Measurement

### (Measurement Method)

For Example 12 (1 wt %), Example 13 (3 wt %), Example 15 (6 wt %), Example 18 (10 wt %) and Comparative Example 1 (None: 0 wt %), the X-ray photoelectron spectra (XPS: X-ray photoelectron spectrum) were measured in order to analyze the electronic state.

In more detail, powder samples of each catalyst of the Examples and Comparative Examples were fixed to a sample holder using carbon tape, and the X-ray photoelectron spectrum was measured.
As the measurement device, a JPS-9010MX photoelectron spectrometer manufactured by JEOL Ltd. was used.

### (Measurement Results)

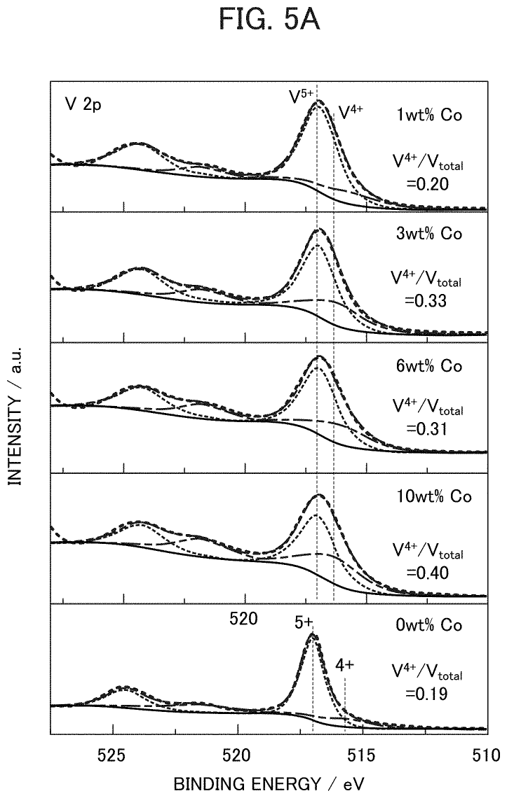

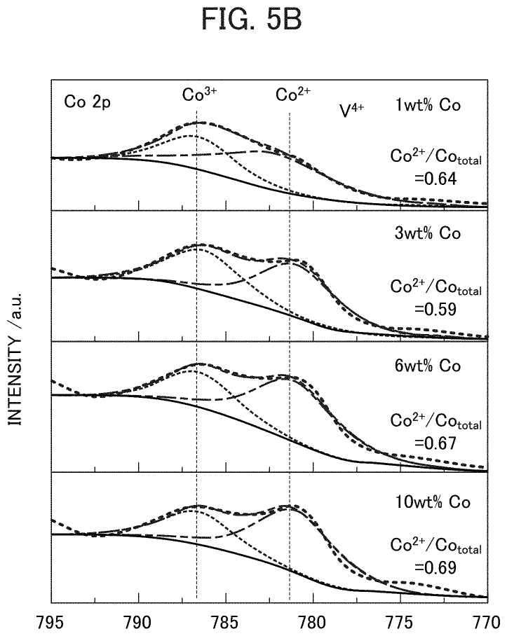

FIG. 5A shows the XPS spectra in the V2p region.

FIG. 5B shows the XPS spectra in the Co2p region.
When raising the added amount of Co, it is shown that V⁴⁺ and Co²⁺ components increased.

### 3 Vanadium Catalyst Containing Tungsten as Second Metal

### 3.1 Case of Varying Added Amount of Tungsten

### 3.1.1 Each Example and Comparative Example

As mentioned above, for the vanadium catalysts of Examples 1 to 11, in both the case of moisture not coexisting and the case of moisture coexisting, since Example 2 (adding tungsten) showed the highest NO conversion rate, the vanadium catalysts according to each of the below Examples were produced by varying the added amount of tungsten.

It should be noted that, not only was the added amount of tungsten simply varied, the added amount of tungsten was varied for each of the cases of using K₂WO₄ and cases of using H₃PW₁₂O₄₀.nH₂O as the precursor, as described later.

### Example 19

To a mixture of ammonium vanadate (NH₄VO₃), 43.9 mmol of K₂WO₄ and 20 ml of pure water, 11.9 g (131.7 mmol) of oxalic acid ((COOH)₂) was added, and after stirring at room temperature for 10 minutes, it was stirred for 12 hours at 70° C.

By firing this precursor complex for 4 hours at 300° C., a denitration catalyst of vanadium pentoxide (V₂O₅) containing tungsten (W) was obtained.
It should be noted that, for W in the produced denitration catalyst, the amount of ammonium vanadate as a raw material was adjusted so that the total weight ratio by metal oxide (WO₃) conversion became 4.9 wt %.

### Example 20

To a mixture of ammonium vanadate (NH₄VO₃), 43.9 mmol of K₂WO₄ and 20 ml of pure water, 11.9 g (131.7 mmol) of oxalic acid ((COOH)₂) was added, and after stirring at room temperature for 10 minutes, it was stirred for 12 hours at 70° C.

By firing this precursor complex for 4 hours at 300° C., a denitration catalyst of vanadium pentoxide (V₂O₅) containing tungsten (W) was obtained.
It should be noted that, for W in the produced denitration catalyst, the amount of ammonium vanadate as a raw material was adjusted so that the total weight ratio by metal oxide (WO₃) conversion became 11.8 wt %.

### Example 21

To a mixture of ammonium vanadate (NH₄VO₃), 43.9 mmol of K₂WO₄ and 20 ml of pure water, 11.9 g (131.7 mmol) of oxalic acid was added, and after stirring at room temperature for 10 minutes, it was stirred for 12 hours at 70° C.

By firing this precursor complex for 4 hours at 300° C., a denitration catalyst of vanadium pentoxide (V₂O₅) containing tungsten (W) was obtained.
It should be noted that, for W in the produced denitration catalyst, the amount of ammonium vanadate as a raw material was adjusted so that the total weight ratio by metal oxide (WO₃) conversion became 22.1 wt %.

### Comparative Example 2

To a mixture of ammonium vanadate (NH₄VO₃), 43.9 mmol of K₂WO₄ and 20 ml of pure water, 11.9 g (131.7 mmol) of oxalic acid ((COOH)₂) was added, and after stirring at room temperature for 10 minutes, it was stirred for 12 hours at 70° C.

By firing this precursor complex for 4 hours at 300° C., a denitration catalyst of vanadium pentoxide (V₂O₅) containing tungsten (W) was obtained.
It should be noted that, for W in the produced denitration catalyst, the amount of ammonium vanadate as a raw material was adjusted so that the total weight ratio by metal oxide (WO₃) conversion became about 100 wt %.

It should be noted that Table 7 below shows the charging amount of precursor during tungsten introduction in Examples 19 to 21, and Comparative Example 2.

TABLE 7
charging amount of precursor during cobalt introduction

| | WO₃ | Precursor/ | Precursor/ | NH₄VO₃/ | NH₄VO₃/ | Oxalic acid/ | Oxalic acid/ |
|---|---|---|---|---|---|---|---|
| | wt % | mmol | g | mmol | g | mmol | g |
| Example 19 | 4.9 | 0.88 | 0.29 | 43 | 5.04 | 131.70 | 11.86 |
| Example 20 | 11.8 | 2.20 | 0.72 | 42 | 4.88 | 131.70 | 11.86 |
| Example 21 | 22.1 | 4.39 | 1.43 | 40 | 4.63 | 131.70 | 11.86 |
| Comparative | 100 | 43.93 | 14.32 | 0.0 | 0.00 | 131.70 | 11.86 |
| Example 1 | | | | | | | |

### Example 22

To a mixture of ammonium vanadate (NH₄VO₃), H₃PW₁₂O₄₀.nH₂O and 20 ml of pure water, 11.9 g (131.7 mmol) of oxalic acid ((COOH)₂) was added, and after stirring at room temperature for 10 minutes, it was stirred for 12 hours at 70° C.

By firing this precursor complex for 4 hours at 300° C., a denitration catalyst of vanadium pentoxide (V₂O₅) containing tungsten (W) was obtained.
It should be noted that, for W in the produced denitration catalyst, the amount of ammonium vanadate and H₃PW₁₂O₄₀.nH₂O as raw materials were adjusted so that the total weight ratio by metal oxide (WO₃) conversion became 38.4 wt %.

### Comparative Example 3

To a mixture of ammonium vanadate (NH₄VO₃), H₃PW₁₂O₄₀.nH₂O and 20 ml of pure water, 11.9 g (131.7 mmol) of oxalic acid ((COOH)₂) was added, and after stirring at room temperature for 10 minutes, it was stirred for 12 hours at 70° C.

By firing this precursor complex for 4 hours at 300° C., a denitration catalyst of vanadium pentoxide (V₂O₅) containing tungsten (W) was obtained.
It should be noted that, for W in the produced denitration catalyst, the amount of ammonium vanadate and H₃PW₁₂O₄₀.nH₂O as raw materials were adjusted so that the total weight ratio by metal oxide (WO₃) conversion became 61.7 wt %.

### Comparative Example 4

To a mixture of ammonium vanadate (NH₄VO₃), H₃PW₁₂O₄₀.nH₂O and 20 ml of pure water, 11.9 g (131.7 mmol) of oxalic acid ((COOH)₂) was added, and after stirring at room temperature for 10 minutes, it was stirred for 12 hours at 70° C.

By firing this precursor complex for 4 hours at 300° C., a denitration catalyst of vanadium pentoxide (V₂O₅) containing tungsten (W) was obtained.
It should be noted that, for W in the produced denitration catalyst, the amount of ammonium vanadate and H₃PW₁₂O₄₀.nH₂O as raw materials were adjusted so that the total weight ratio by metal oxide (WO₃) conversion became 77.3 wt %.

### Comparative Example 5

To a mixture of ammonium vanadate (NH₄VO₃), H₃PW₁₂O₄₀.nH₂O and 20 ml of pure water, 11.9 g (131.7 mmol) of oxalic acid ((COOH)₂) was added, and after stirring at room temperature for 10 minutes, it was stirred for 12 hours at 70° C.

By firing this precursor complex for 4 hours at 300° C., a denitration catalyst of vanadium pentoxide (V₂O₅) containing tungsten (W) was obtained.
It should be noted that, for W in the produced denitration catalyst, the amount of ammonium vanadate and H₃PW₁₂O₄₀.nH₂O as raw materials were adjusted so that the total weight ratio by metal oxide (WO₃) conversion became 84.4 wt %.

### Comparative Example 6

To a mixture of ammonium vanadate (NH₄VO₃), H₃PW₁₂O₄₀.nH₂O and 20 ml of pure water, 11.9 g (131.7 nmol) of oxalic acid ((COOH)₂) was added, and after stirring at room temperature for 10 minutes, it was stirred for 12 hours at 70° C.

By firing this precursor complex for 4 hours at 300° C., a denitration catalyst of vanadium pentoxide (V₂O₅) containing tungsten (W) was obtained.
It should be noted that, for W in the produced denitration catalyst, the amount of ammonium vanadate and H₃PW₁₂O₄₀.nH₂O as raw materials were adjusted so that the total weight ratio by metal oxide (WO₃) conversion became about 100 wt %.

It should be noted that Table 8 below shows the charging amount of precursor during tungsten introduction in Example 22, and Comparative Examples 3 to 6.

TABLE 8
charging amount of precursor during cobalt introduction

| | WO₃ | Precursor/ | Precursor/ | NH₄VO₃/ | NH₄VO₃/ | Oxalic acid/ | Oxalic acid/ |
|---|---|---|---|---|---|---|---|
| | wt % | mmol | g | mmol | g | mmol | g |
| Example 22 | 38.4 | 0.88 | 2.53 | 43.05 | 5.04 | 131.70 | 11.86 |
| Comparative | 61.7 | 2.20 | 6.33 | 41.73 | 4.88 | 131.70 | 11.86 |
| Example 3 | | | | | | | |
| Comparative | 77.3 | 4.39 | 12.65 | 39.54 | 4.63 | 131.70 | 11.86 |
| Example 4 | | | | | | | |
| Comparative | 84.4 | 6.59 | 18.98 | 37.34 | 4.37 | 131.70 | 11.86 |
| Example 5 | | | | | | | |
| Comparative | 100 | 4.88 | 14.06 | 0.00 | 0.00 | 131.70 | 11.86 |
| Example 6 | | | | | | | |

### 3.1.2 Evaluation

### 3.1.2.1 Outline

Under the conditions of the above Table 3, the NH₃—SCR reaction was conducted using a fixed bed flow-type reactor at a reaction temperature of 150° C.

In the gas passing through the catalyst layer, NO was analyzed by a Jasco FT-IR-4700.
In addition, the NO conversion rate was calculated by Formula (1) above.

### (Measurement Results)

Table 9 shows the NO conversion rates for both the case of moisture not coexisting and the case of coexistence of moisture of each vanadium pentoxide catalyst.

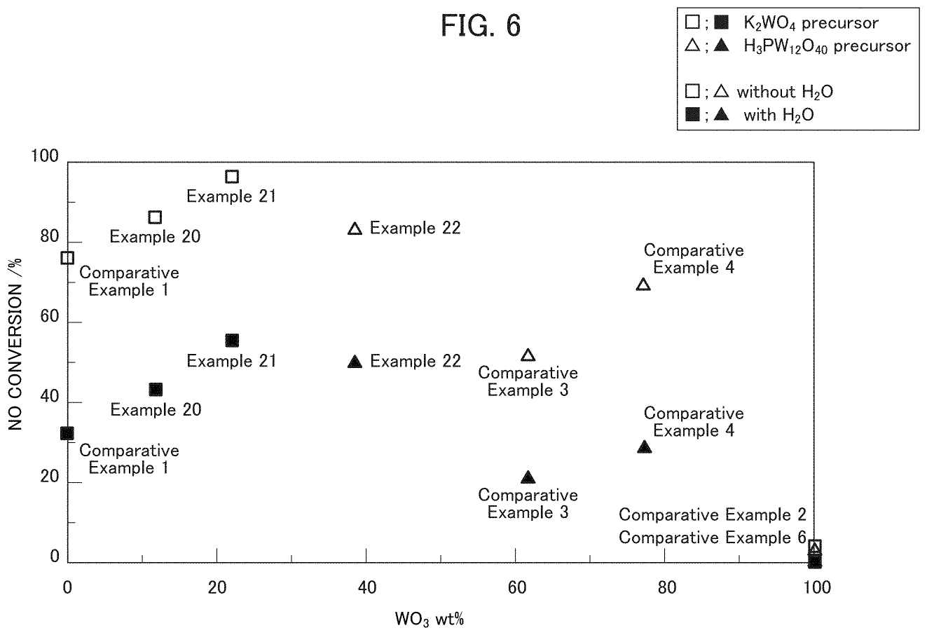

FIG. 6 is a plot graphing this Table 9.

TABLE 9
NOx conversion rate of vanadium pentoxide catalyst

| | | NO conversion rate/% | |
|---|---|---|---|
| Sample | | dry | wet (2.3%) |
| Comparative | (None) | 76 | 32 |
| Example 1 | | | |
| Example 20 | (12 wt %) | 86 | 43 |
| Example 21 | (22 wt %) | 96 | 55 |
| Example 22 | (38 wt %) | 83 | 50 |
| Comparative | (62 wt %) | 52 | 21 |
| Example 3 | | | |
| Comparative | (77 wt %) | 69 | 28 |
| Example 4 | | | |
| Comparative | (100 wt %) | 4 | 0 |
| Example 2 | | | |
| Comparative | (100 wt %) | 3 | 0 |
| Example 6 | | | |

In both the case of moisture not coexisting and the case under coexistence of moisture, when comparing Comparative Example 1 having a tungsten content of 0 wt % and Comparative Examples 2 to 4 and 6 having a tungsten content of 52 wt % to 100 wt %, it generally showed that addition is effective between the added amounts of tungsten of 12 wt % to 38 wt %.

Hereinafter, for each of a case of using K₂WO₄ and a case of using H₃PW₁₂O₄₀.nH₂O as the precursor, elemental analysis was conducted by powder X-ray diffraction and SEM-EDS, and the NO conversion rate for every tungsten content ratio was graphed for each case.

3.2.2 Case using K₂WO₄ as Precursor

### 3.1.2.2.1 Powder X-ray Diffraction and Elemental Analysis

### (Measurement Method)

The powder X-ray diffraction, measurement was performed using Cu-Kα by a Rigaku Smart Lab.

In addition, elemental analysis by SEM-EDS was conducted.

### (Measurement Results)

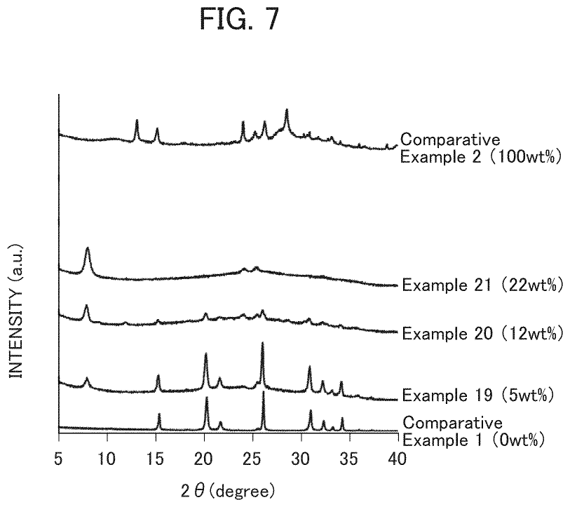

FIG. 7 shows the powder XRD patterns of Example 19 (4.9 wt %), Example 20 (11.8 wt %), Example 21 (22.1 wt %), Comparative Example 1 (0 wt %) and Comparative Example 2 (100 wt %).

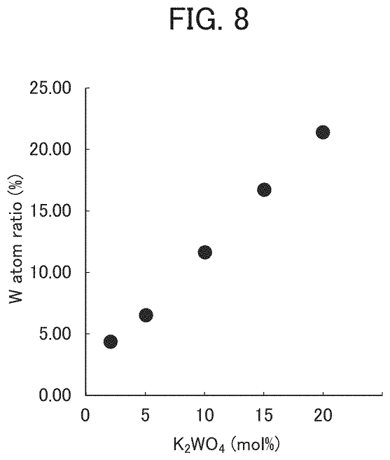

In addition, FIG. 8 shows the proportion (%) of tungsten element in the case of establishing the horizontal axis as mol % of K₂WO₄.

From FIGS. 7 and 8, it was shown that, by increasing K₂WO₄, the crystalline phase became monoclinic WO₃ (100 wt %) through triclinic V₄O₇ (12 wt %), and the ratio of tungsten atoms included in the catalyst proportionally increased.

### 3.1.2.2.2 NO Conversion Rate

### (Measurement Results)

Table 10 shows the NO conversion rates for both the case of moisture not coexisting and the case of coexistence of moisture of each vanadium pentoxide catalyst.

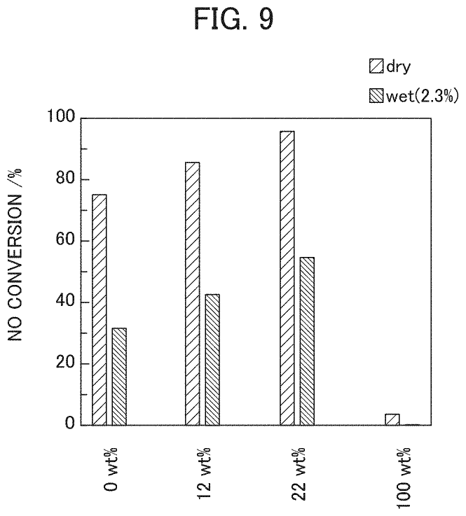

FIG. 9 is a plot graphing this Table 10.

TABLE 10
NOx conversion rate of vanadium pentoxide catalyst

| | | NO conversion rate/% | |
|---|---|---|---|
| Sample | | dry | wet (2.3%) |
| Comparative | (None) | 76 | 32 |
| Example 1 | | | |
| Example 20 | (12 wt %) | 86 | 43 |
| Example 21 | (22 wt %) | 96 | 55 |
| Comparative | (100 wt %) | 4 | 0 |
| Example 2 | | | |

As found from Table 10 and FIG. 9, the catalytic activity reached a maximum (96.3%) with triclinic V₄O₇ (22.1 wt %).

In addition, the excess K₂WO₄ leads to a decline in catalytic activity, and there was no catalytic activity with the content of tungsten of 100 wt %.
3.1.2.3 Case Using H₃PW₁₂O₄₀.nH₂O as Precursor

### 3.1.2.3.1 Powder X-ray Diffraction and Elemental Analysis

### (Measurement Method)

The power X-ray diffraction, measurement was performed using Cu-Kα by a Rigaku Smart Lab.

In addition, elemental analysis by SEM-EDS was conducted.

### (Measurement Results)

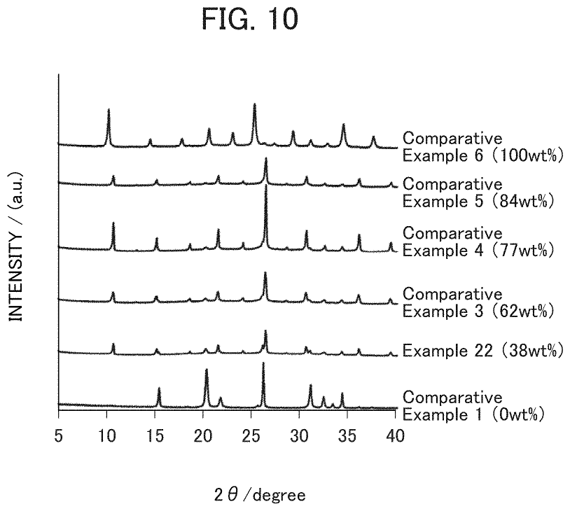

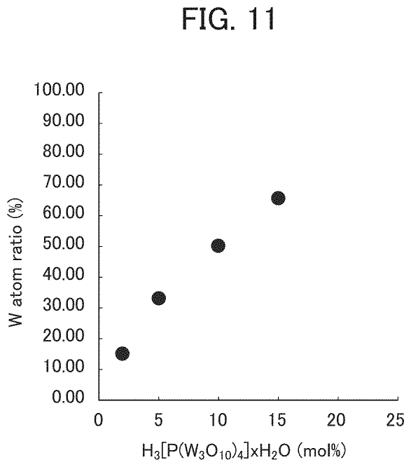

FIG. 10 shows the powder XRD patterns of Example 22 (38.4 wt %), Comparative Example 3 (61.7 wt %), Comparative Example 4 (77.3 wt %), Comparative Example 5 (84.4 wt %) and Comparative Example 6 (100 wt %). In addition, FIG. 11 shows the proportion (%) of tungsten element in the case of establishing the horizontal axis as mol % of H₃PW₁₂O₄₀.nH₂O.

From FIGS. 10 and 11, it is shown that by increasing the charging amount of H₃PW₁₂O₄₀.nH₂O, the diffraction peak derived from H₃PW₁₂O₄₀.nH₂O became larger, and the content of tungsten became abundant with a charging amount which was a relatively small amount.

### 3.1.2.3.2 NO Conversion Rate

### (Measurement Results)

Table 11 shows the NO conversion rates for both the case of moisture not coexisting and the case of coexistence of moisture of each vanadium pentoxide catalyst.

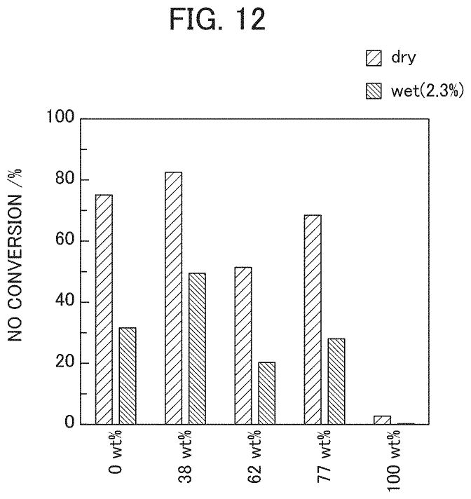

FIG. 12 is a plot graphing this Table 11.

TABLE 11
NOx conversion rate of vanadium pentoxide catalyst

| | | NO conversion rate/% | |
|---|---|---|---|
| Sample | | dry | wet (2.3%) |
| Comparative | (None) | 76 | 32 |
| Example 1 | | | |
| Example 22 | (38 wt %) | 83 | 50 |
| Comparative | (62 wt %) | 52 | 21 |
| Example 3 | | | |
| Comparative | (77 wt %) | 69 | 28 |
| Example 4 | | | |
| Comparative | (100 wt %) | 3 | 0 |
| Example 6 | | | |

As found from Table 11 and FIG. 12, for the case of establishing H₃PW₁₂O₄₀.nH₂O as the precursor, although the catalytic activity reached a maximum (82.9%) with the content of tungsten of 38.4 wt %, the vanadium catalyst establishing K₂WO₄ as the precursor and having a content of tungsten of 22.1 wt % had results of higher catalytic activity.

3.2 Case using Metatungstic Acid as Precursor

As mentioned above, during production of the vanadium catalysts of Example 2 and Examples 19 to 22, paratungstic acid was used as precursor.

However, paratungstic acid has a characteristic of the solubility in water not being very high.
For this reason, the possibility of tungsten being mixed nonunifoimly in the catalyst was suggested.
The metatungstic acid has a high solubility in water compared to paratungstic acid.
Therefore, vanadium catalyst containing tungsten as the second metal was produced by establishing metatungstic acid as the precursor in place of paratungstic acid.

### 3.2.1 Each Example and Comparative Example

### Example 23

To a mixture of ammonium vanadate (NH₄VO₃), 0.037 mmol of metatungstic acid and 20 ml of pure water, 11.9 g (131.7 mmol) of oxalic acid ((COOH)₂) was added, and after stirring at room temperature for 10 minutes, it was stirred for 12 hours at 70° C.

By firing this precursor complex for 4 hours at 300° C., a denitration catalyst of vanadium pentoxide (V₂O₅) containing tungsten (W) was obtained.
It should be noted that, for W in the produced denitration catalyst, the amount of ammonium vanadate as a raw material was adjusted so that the total weight ratio of WO₃ by metal oxide (WO₃) conversion became 2.5 wt % (1.0 mol %).

### Example 24

To a mixture of ammonium vanadate (NH₄VO₃), 0.073 mmol of metatungstic acid and 20 ml of pure water, 11.9 g (131.7 mmol) of oxalic acid ((COOH)₂) was added, and after stirring at room temperature for 10 minutes, it was stirred for 12 hours at 70° C.

By firing this precursor complex for 4 hours at 300° C., a denitration catalyst of vanadium pentoxide (V₂O₅) containing tungsten (W) was obtained.
It should be noted that, for W in the produced denitration catalyst, the amount of ammonium vanadate as a raw material was adjusted so that the total weight ratio of WO₃ by metal oxide (WO₃) conversion became 4.9 wt % (2.0 mol %).

### Example 25

To a mixture of ammonium vanadate (NH₄VO₃), 0.128 mmol of metatungstic acid and 20 ml of pure water, 11.9 g (131.7 mmol) of oxalic acid ((COOH)₂) was added, and after stirring at room temperature for 10 minutes, it was stirred for 12 hours at 70° C.

By firing this precursor complex for 4 hours at 300° C., a denitration catalyst of vanadium pentoxide (V₂O₅) containing tungsten (W) was obtained.
It should be noted that, for W in the produced denitration catalyst, the amount of ammonium vanadate as a raw material was adjusted so that the total weight ratio of WO₃ by metal oxide (WO₃) conversion became 8.5 wt % (3.5 mol %).

### Example 26

To a mixture of ammonium vanadate (NH₄VO₃), 0.183 mmol of metatungstic acid and 20 ml of pure water, 11.9 g (131.7 mmol) of oxalic acid ((COOH)₂) was added, and after stirring at room temperature for 10 minutes, it was stirred for 12 hours at 70° C.

By firing this precursor complex for 4 hours at 300° C., a denitration catalyst of vanadium pentoxide (V₂O₅) containing tungsten (W) was obtained.
It should be noted that, for W in the produced denitration catalyst, the amount of ammonium vanadate as a raw material was adjusted so that the total weight ratio of WO₃ by metal oxide (WO₃) conversion became 11.8 wt % (5.0 mol %).

### Example 27

To a mixture of ammonium vanadate (NH₄VO₃), 0.256 mmol of metatungstic acid and 20 ml of pure water, 11.9 g (131.7 mmol) of oxalic acid ((COOH)₂) was added, and after stirring at room temperature for 10 minutes, it was stirred for 12 hours at 70° C.

By firing this precursor complex for 4 hours at 300° C., a denitration catalyst of vanadium pentoxide (V₂O₅) containing tungsten (W) was obtained.
It should be noted that, for W in the produced denitration catalyst, the amount of ammonium vanadate as a raw material was adjusted so that the total weight ratio of WO₃ by metal oxide (WO₃) conversion became 16.1 wt % (7.0 mol %).

### Comparative Example 7

To a mixture of 0.17 mmol of ammonium vanadate (NH₄VO₃), 0.028 mmol of metatungstic acid and 20 ml of pure water, 0.045 g (0.51 mmol) of oxalic acid ((COOH)₂) and 1.4 g of titanium oxide powder were added, and after stirring at room temperature for 10 minutes, it was stirred for 12 hours at 70° C.

By firing this precursor complex for 4 hours at 300° C., a denitration catalyst of vanadium pentoxide (V₂O₅) containing tungsten (W) loaded on titanium oxide was obtained.

### 3.2.2 Evaluation

### 3.2.2.1 NO Conversion Rate

### (Measurement Method)

For the tungsten-containing vanadium pentoxide catalysts of Example 25 and Example 2, the NH₃—SCR reaction was conducted using a fixed bed flow-type reactor at a reaction temperature of 150° C. under the conditions of Table 12 below, under a dry atmosphere in the first stage, under a 10% moisture atmosphere in the second stage, and finally under a dry atmosphere again in the third stage.

In the gas passing through the catalyst layer, NO was analyzed by a Jasco FT-IR-4700.

TABLE 12
NH₃-SCR measurement conditions

| | |
|---|---|
| Reaction temperature | 150° C. |
| Catalyst amount | 0.375 g |
| Gas flow rate | 250 ml min⁻¹ |
| | NO: 250 ppm, NH₃: 250 ppm, O₂: 4 vol % |
| | in Ar, 10% H₂O (steam atmosphere) |
| Space velocity | 40,000 mL h⁻¹g_{cat}⁻¹ |

In addition, the NO conversion rate was calculated by Formula (1) above.

### (Measurement Results)

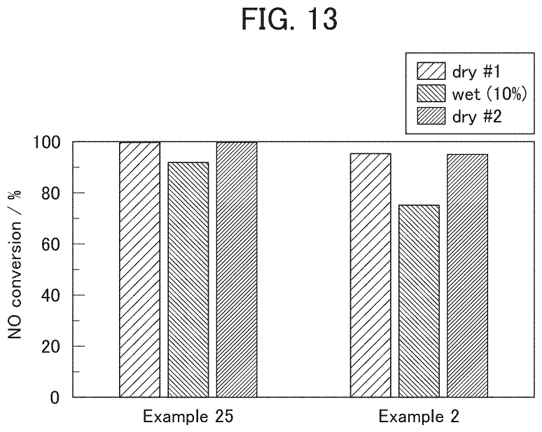

FIG. 13 show the NO conversion rates of the first stage to third stage of each vanadium pentoxide catalyst.

In all stages among the first stage to third stage, the NO conversion rate of vanadium catalyst of Example 25 was higher than the NO conversion rate of vanadium catalyst of Example 2.
In addition, it was shown that, for both the vanadium catalyst of Example 25 and vanadium catalyst of Example 2, under the dry atmosphere after the third stage after subjecting to the 10% moisture atmosphere of the second stage, they returned to a NO conversion rate almost equal to the NO conversion rate under the dry atmosphere of the first stage.

### 3.2.2.2 Specific Surface Area

### (Measurement Method)

For the tungsten-containing vanadium pentoxide catalysts of Example 25 and Example 2, and the vanadium pentoxide catalyst of Comparative Example 1, the specific surface area under a dry atmosphere in the first stage, and under the 10% moisture atmosphere in the second stage, was measured using a fixed bed flow-type reactor at a reaction temperature of 150° C., under the conditions of the above Table 12, similarly to the measurement method of NO conversion rate in 3.2.2.1.

### (Measurement Results)

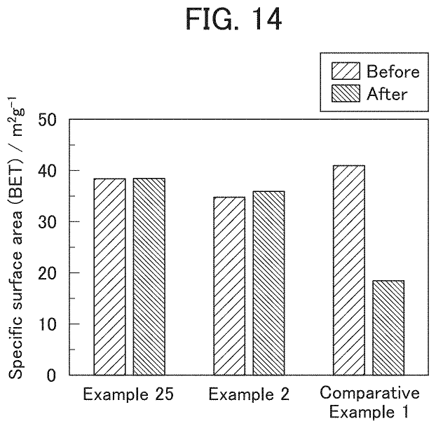

FIG. 14 shows the variation in specific surface area before and after use of each vanadium pentoxide catalyst.

As is evident when comparing Example 25 and Example 2 with Comparative Example 1, the decline in specific surface area before and after use was suppressed by adding tungsten.
In addition, it was shown that the vanadium pentoxide catalyst of Example 25 made using metatungstic acid as a precursor has slightly greater specific surface area than the vanadium pentoxide catalyst of Example 2 made using paratungstic acid as a precursor.

### 3.2.2.3 Water Concentration Dependency of Catalytic Activity

### (Measurement Method)

For the tungsten-containing vanadium pentoxide catalysts of Example 25 and Example 2, and the vanadium pentoxide catalyst of Comparative Example 1, similarly to the measurement method of the NO conversion rate in 3.2.2.1, the specific surface area was measured using a fixed bed flow-type reactor at a reaction temperature of 150° C., under the conditions of the above Table 10, under a dry atmosphere in the first stage, under a 20% moisture atmosphere in the second stage, under a 15% moisture atmosphere in the third stage, under a 10% moisture atmosphere in the fourth stage, under a 5% moisture atmosphere in the fifth stage, and under a dry atmosphere again in the sixth stage.

### (Measurement Method)

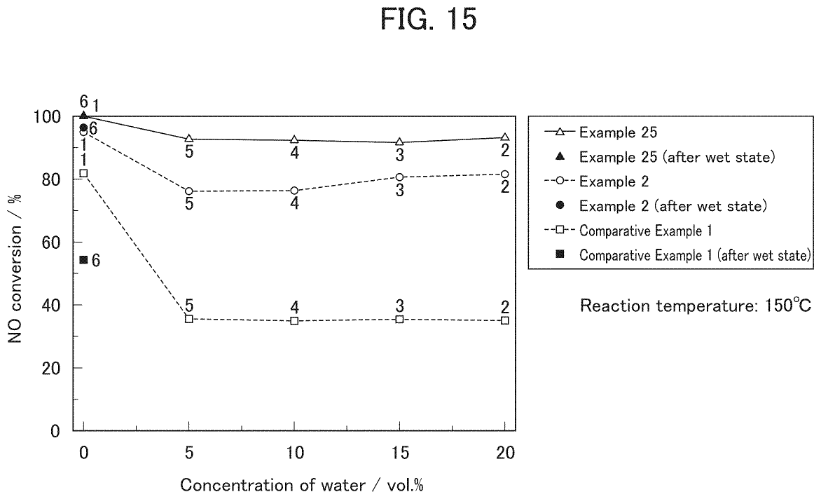

FIG. 15 shows the transition in NO conversion rates in the first to sixth stages of each vanadium pentoxide catalyst.

The tungsten-containing vanadium pentoxide catalyst differs from the vanadium pentoxide catalyst not containing tungsten, and recovered to the original NO conversion rate, even after conducting NH₃—SCR reaction under the 20% moisture atmosphere.
In addition, the vanadium pentoxide catalyst of Example 25 made using metatungstic acid as the precursor shows a higher NO conversion rate, than the vanadium pentoxide catalyst of Example 2 made using paratungstic acid as the precursor.

### 3.2.2.4 Tungsten Amount Dependency of Catalytic Activity

### (Measurement Method)

For the tungsten-containing vanadium pentoxide catalysts of Examples 23 to 27, and vanadium pentoxide catalyst of Comparative Example 1, similarly to the measurement method of NO conversion rate in 3.2.2.1, the NO conversion rate was measured using a fixed bed flow-type reactor at a reaction temperature of 150° C. under the conditions of the above Table 12, under a dry atmosphere, and under a 10% moisture atmosphere.

### (Measurement Results)

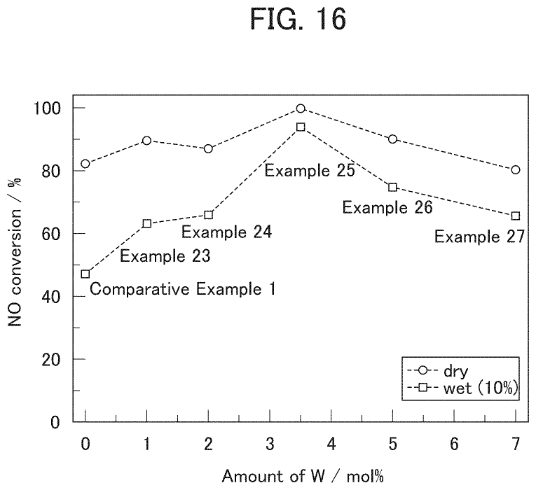

FIG. 16 shows the NO conversion rates under a dry atmosphere and under a 10% moisture atmosphere of each vanadium pentoxide catalyst. Under both a dry atmosphere and a 10% moisture atmosphere, Example 25, i.e. vanadium pentoxide catalyst with 3.5 mol % tungsten addition, showed the highest NO conversion rate, i.e. highest activity.

### 3.2.2.5 Temperature Dependency of Catalytic Activity

### (Measurement Method)

For the tungsten-containing vanadium pentoxide catalyst of Example 25, the vanadium pentoxide catalyst of Comparative Example 1 and the titania-supported tungsten-vanadium catalyst of Comparative Example 7, the NH₃—SCR reaction was conducted under a 10% moisture atmosphere, using a fixed bed flow-type reactor at a reaction temperature of 25° C. to 245° C. under the conditions of Table 13 below. In the gas passing through the catalyst layer, NO was analyzed by a Jasco FT-IR-4700.

TABLE 13
NH₃-SCR measurement conditions

| | |
|---|---|
| Reaction temperature | 25° C.~245° C. |
| Catalyst amount | 0.375 g |
| Gas flow rate | 250 ml min⁻¹ |
| | NO: 250 ppm, NH₃: 250 ppm, O₂: 4 vol % |
| | in Ar, 10% H₂O (steam atmosphere) |
| Space velocity | 40,000 mL h⁻¹g_{cat}⁻¹ |

### (Measurement Results)

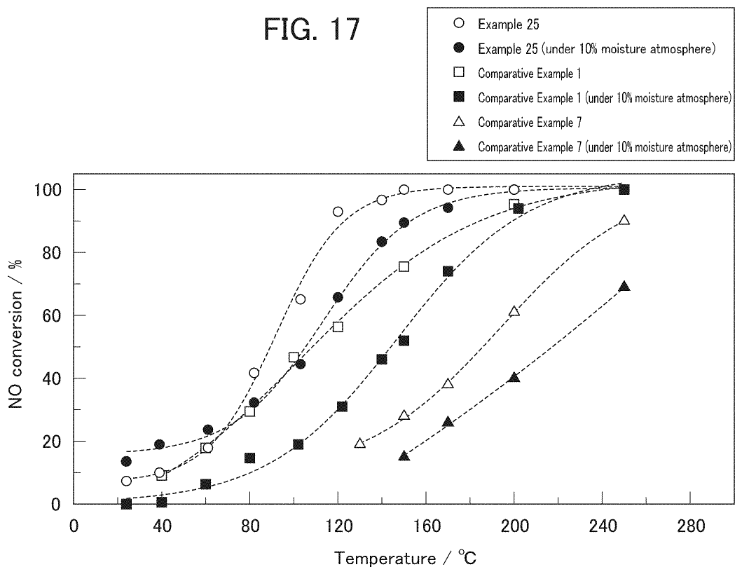

FIG. 17 shows the NO conversion rate at reaction temperatures of 25° C. to 245° C. of each vanadium pentoxide catalyst.

From FIG. 17, the tungsten-containing vanadium pentoxide catalyst showed high NO conversion rate, high activity, even in a low temperature region, compared to the catalyst loaded on titania.

### 3.2.2.6 TEM Images of Each Catalyst

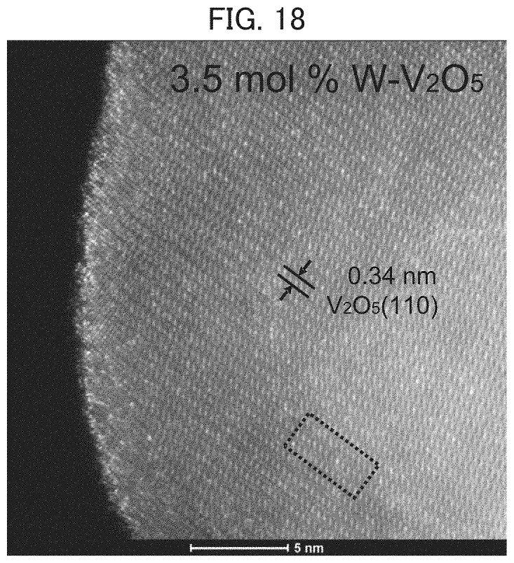

FIG. 18 shows the TEM image of the tungsten-containing vanadium pentoxide catalyst of Example 25.

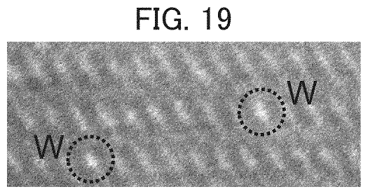

It should be noted that the magnification is 4,400,000 times.
In addition, FIG. 19 is an enlarged image of the rectangular part shown in FIG. 18.
Each white dot shown in the image of FIG. 18 is an atom of vanadium or tungsten, and above all, the bright points among the white points are atoms of tungsten, as elucidated in FIG. 19.
As is found from FIGS. 18 and 19, tungsten disperses in the form of atoms, in the tungsten-containing vanadium pentoxide catalyst of Example 25.
In addition, in some way or other, tungsten more strongly supports the skeleton of the vanadium pentoxide, and becomes a form in which tungsten substitutes positions of vanadium in the crystallites.

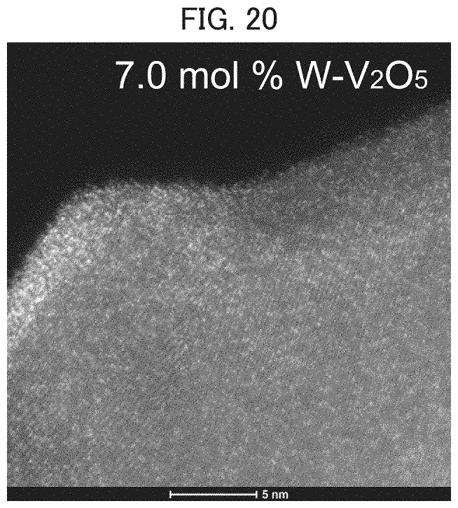

FIG. 20 shows a TEM image of the tungsten-containing vanadium pentoxide catalyst of Example 27.

It should be noted that the magnification is 4,400,000 times.
In FIG. 20, the number of bright points among the white points increases, compared to the tungsten-containing vanadium pentoxide catalyst of Example 25 shown in FIG. 18.
This is because the tungsten sites of cluster form increased by the loading amount of tungsten increasing.

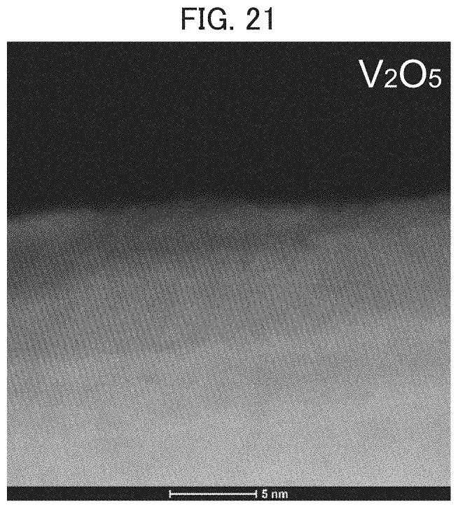

FIG. 21 shows the TEM image of the vanadium pentoxide catalyst not containing tungsten of Comparative Example 1.

It should be noted that the magnification is 4,400,000 times.
In FIG. 21, bright white points such as those found in FIGS. 18 to 20 are not found.
This is because the vanadium pentoxide catalyst of Comparative Example 1 does not contain tungsten.

### 4 Vanadium Catalyst Containing Niobium as Second Metal

### 4.1 Each Example

As mentioned above, among the vanadium catalysts of Examples 1 to 11, since Example 4 (adding niobium) showed the third highest NO conversion rate in the case of moisture not coexisting, and showed a relatively high NO conversion rate even in the case of moisture coexisting, vanadium catalysts according to each of the following examples were produced by varying the added amount of niobium.

### Example 28

A precursor complex was synthesized by dissolving ammonium vanadate (NH₄VO₃) and oxalic acid ((COOH)₂) in pure water.

To this precursor complex, oxalic acid complex of niobium (Nb), which is the second metal, was added, so that the NbO₂O₅ becomes 1.8 wt % by metal oxide conversion.
By firing the obtained vanadium-niobium complex mixture twice for 4 hours at a temperature of 300° C. by an electric furnace, a denitration catalyst of vanadium pentoxide (V₂O₅) containing niobium (Nb) was obtained.

### Example 29

A precursor complex was synthesized by dissolving ammonium vanadate (NH₄VO₃) and oxalic acid ((COOH)₂) in pure water.

To this precursor complex, oxalic acid complex of niobium (Nb), which is the second metal, was added, so that the NbO₂O₅ becomes 5.2 wt % by metal oxide conversion.
By firing the obtained vanadium-niobium complex mixture twice for 4 hours at a temperature of 300° C. by an electric furnace, a denitration catalyst of vanadium pentoxide (V₂O₅) containing niobium (Nb) was obtained.

### Example 30

A precursor complex was synthesized by dissolving ammonium vanadate (NH₄VO₃) and oxalic acid ((COOH)₂) in pure water.

To this precursor complex, oxalic acid complex of niobium (Nb), which is the second metal, was added, so that the NbO₂O₅ becomes 8.5 wt % by metal oxide conversion.
By firing the obtained vanadium-niobium complex mixture twice for 4 hours at a temperature of 300° C. by an electric furnace, a denitration catalyst of vanadium pentoxide (V₂O₅) containing niobium (Nb) was obtained.

### Example 31

A precursor complex was synthesized by dissolving ammonium vanadate (NH₄VO₃) and oxalic acid ((COOH)₂) in pure water.

To this precursor complex, oxalic acid complex of niobium (Nb), which is the second metal, was added, so that the NbO₂O₅ becomes 11.7 wt % by metal oxide conversion.
By firing the obtained vanadium-niobium complex mixture twice for 4 hours at a temperature of 300° C. by an electric furnace, a denitration catalyst of vanadium pentoxide (V₂O₅) containing niobium (Nb) was obtained.

### Example 32

A precursor complex was synthesized by dissolving ammonium vanadate (NH₄VO₃) and oxalic acid ((COOH)₂) in pure water.

To this precursor complex, oxalic acid complex of niobium (Nb), which is the second metal, was added, so that the NbO₂O₅ becomes 16.2 wt % by metal oxide conversion.
By firing the obtained vanadium-niobium complex mixture twice for 4 hours at a temperature of 300° C. by an electric furnace, a denitration catalyst of vanadium pentoxide (V₂O₅) containing niobium (Nb) was obtained.

It should be noted that Table 14 below shows the charging amount of precursor during niobium introduction in Examples 28 to 32.

TABLE 14
charging amount of precursor during niobium introduction

| | | Niobium | Niobium | | | | |
|---|---|---|---|---|---|---|---|
| | Nb₂O₅ | precursor/ | precursor/ | NH₄VO₃/ | NH₄VO₃/ | Oxalic acid/ | Oxalic acid/ |
| | wt % | mmol | g | mmol | g | mmol | g |
| Example 28 | 1.8 | 0.54 | 0.16 | 43.6 | 5.10 | 130.8 | 11.77 |
| Example 29 | 5.2 | 1.62 | 0.49 | 43.0 | 5.03 | 129.0 | 11.61 |
| Example 30 | 8.5 | 2.70 | 0.82 | 42.4 | 4.96 | 127.1 | 11.45 |
| Example 31 | 11.7 | 3.78 | 1.14 | 41.8 | 4.89 | 125.3 | 11.28 |
| Example 32 | 18.2 | 5.40 | 1.64 | 40.9 | 4.78 | 122.6 | 11.04 |

### 4.2 Evaluation

### 4.2.1 NO Conversion Rate

### (Measurement Method)

Under the conditions of the above Table 3, the NH₃—SCR reaction was conducted using a fixed bed flow-type reactor at a reaction temperature of 150° C.
In the gas passing through the catalyst layer, NO was analyzed by a Jasco FT-IR-4700.
In addition, the NO conversion rate was calculated by Formula (1) above.

### (Measurement Results)

Table 15 shows the NO conversion rates for both the case of moisture not coexisting and the case under coexistence of moisture of each vanadium oxide catalyst.

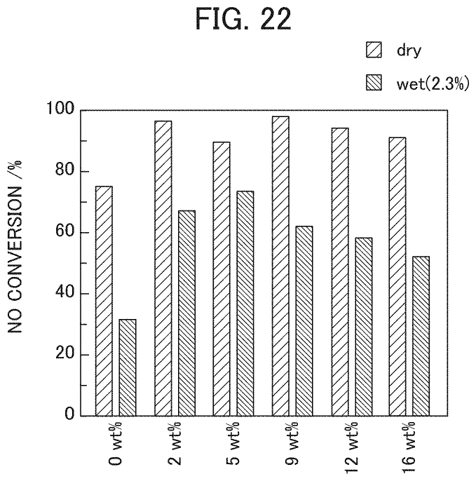

FIG. 22 is a plot graphing this Table 15.

TABLE 15
NOx conversion rate of vanadium pentoxide catalyst

| | | NO conversion rate/% | |
|---|---|---|---|
| Sample | | dry | wet (2.3%) |
| Comparative | (None) | 76 | 32 |
| Example 1 | | | |
| Example 28 | (2 wt %) | 96 | 66 |
| Example 29 | (5 wt %) | 90 | 73 |
| Example 30 | (9 wt %) | 97 | 62 |
| Example 31 | (12 wt %) | 94 | 60 |
| Example 32 | (16 wt %) | 91 | 52 |

In both the case of moisture not coexisting and the case under coexistence of moisture, the denitration catalyst of the Examples showed higher NO conversion rate than the denitration catalyst of the Comparative Example.

Above all, in the case of moisture not coexisting, Example 30 (9 wt %) showed the highest NO conversion rate, and in the case of moisture coexisting, Example 29 (5 wt %) showed the highest NO conversion rate.

### 5 Vanadium Catalyst Containing Carbon and Cobalt as Second Metal, and Fired at Low Temperature

### 5.1 Each Example

### Example 33

A precursor complex was synthesized by dissolving ammonium vanadate (NH₄VO₃) and oxalic acid in pure water.

To this precursor complex, ethylene glycol and an oxalic acid complex which is a precursor of cobalt (Co), which is the second metal, were added, so that Co₃O₄ becomes 6 wt % by metal oxide conversion.
By firing the obtained catalyst complex for 2 hours at a temperature of 270° C. by an electric furnace, a denitration catalyst of vanadium oxide containing carbon and cobalt (Co) was obtained.
It should be noted that Table 16 below shows the charging amount of precursor during cobalt introduction in Example 33.

TABLE 16
Charging amount of precursor

| | | Co complex | | NH₄VO₃ | | Oxalic acid | | Ethylene glycol | |
|---|---|---|---|---|---|---|---|---|---|
| | Co₃O₄ wt % | mmol | g | mmol | g | mmol | g | mmol | g |
| Example 33 | 6 | 2.88 | 1.40 | 41.0 | 4.80 | 123.07 | 11.08 | 13.8 | 0.86 |

### 5.2 Evaluation

### 5.2.1 Carbon Content

### (Measurement Method)

Upon measurement of carbon content of each vanadium pentoxide catalyst, the carbon content was quantified by elemental analysis of C (carbon), H (hydrogen) and N (nitrogen).

In more detail, in the reaction tube at high temperature inside of a CE-440F made by Exeter Analytical Inc., each denitration catalyst was completely combusted and decomposed to convert the C, H and N which are the main constituent elements into CO₂, H₂O and N₂, followed by sequentially quantifying these three components in three thermal conductivity detectors to measure the contents of C, H and N in the constituent elements.

### (Measurement Results)

The carbon content contained in the vanadium catalyst of Example 33 was 0.70 wt %.

### 5.2.2 NO Conversion Rate

### (Measurement Method)

Under the conditions of the above Table 3, the NH₃—SCR reaction was conducted using a fixed bed flow-type reactor at a reaction temperature of 150° C.
In the gas passing through the catalyst layer, NO was analyzed by a Jasco FT-IR-4700.
In addition, the NO conversion rate was calculated by Formula (1) above.

### (Measurement Results)

Table 17 shows the NO conversion rates for both the case of moisture not coexisting and the case of coexistence of moisture of each vanadium pentoxide catalyst of Comparative Example 1, Example 15 and Example 33.

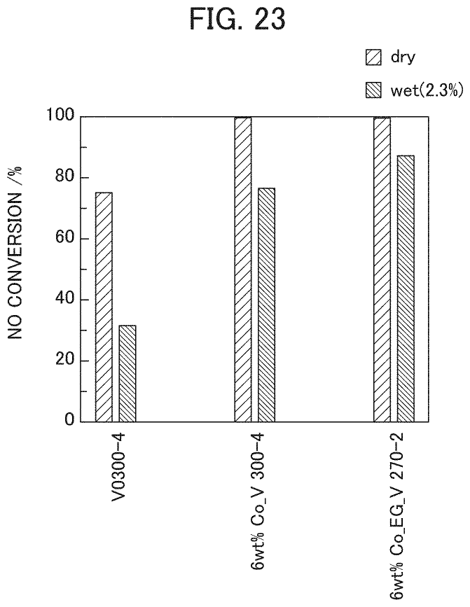

FIG. 23 is a plot graphing this Table 17.

TABLE 17
NOx conversion rate of vanadium pentoxide catalyst

| | | NO conversion rate/% | |
|---|---|---|---|
| Sample | | dry | wet (2.3%) |
| Comparative | (V300-4) | 76 | 32 |
| Example 1 | | | |
| Example 28 | (6 wt % Co_V300-4) | 100 | 77 |
| Example 29 | (6 wt % Co_EG_V270-2) | 100 | 89 |

In both the case of moisture not coexisting and the case under coexistence of moisture, the denitration catalyst of Example 33 showed the highest NO conversion rate.

### 6 Vanadium Catalyst Containing Tungsten as Second Metal and Copper as Third Metal

### 6.1 Each Example

### Example 34

A precursor complex was synthesized by dissolving ammonium vanadate (NH₄VO₃) and oxalic acid in pure water.

To this precursor complex, ammonium metatungstate, which is a precursor of tungsten (W) that is the second metal, was added, so that WO₃ became 8.4 wt % by metal oxide conversion.
Furthermore, a copper oxalic acid complex which is a precursor of copper (Cu that is the third metal was added, so that CuO became 3.0 wt % by metal oxide conversion.
By firing the obtained catalyst precursor twice for 4 hours at a temperature of 300° C. by an electric furnace, a denitration catalyst of vanadium oxide containing tungsten (W) and copper (Cu) was obtained.

### 6.2 Temperature Dependency of Catalytic Activity

### (Measurement Method)

For the tungsten and copper-containing vanadium pentoxide catalyst of Example 34, the tungsten-containing vanadium catalyst of Example 25, and the vanadium pentoxide catalyst of Comparative Example 1, the NH₃—SCR reaction was conducted under a 10% moisture atmosphere, using a fixed bed flow-type reactor at a reaction temperature of 25° C. to 245° C. under the conditions of the above Table 13.

In the gas passing through the catalyst layer, NO was analyzed by a Jasco FT-IR-4700.

### (Measurement Results)

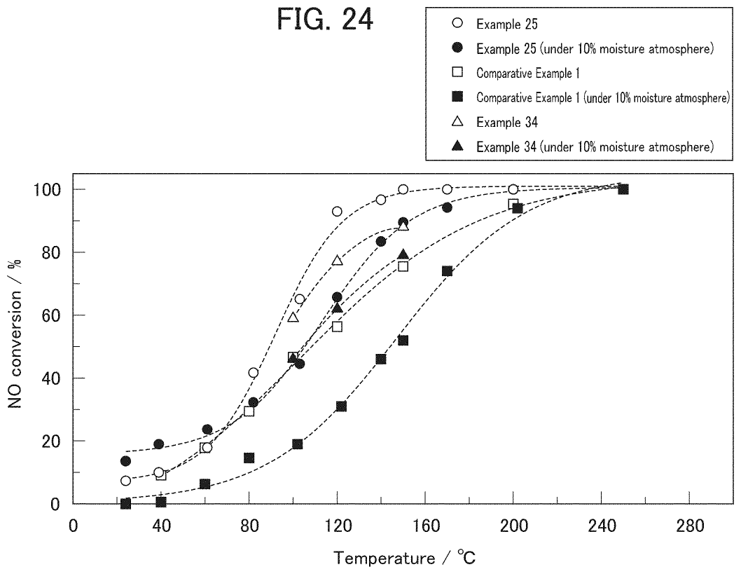

FIG. 24 shows the NO conversion rate at reaction temperatures of 25° C. to 245° C. of each vanadium pentoxide catalyst.

From FIG. 24, the tungsten and copper-containing vanadium pentoxide catalyst showed a NO conversion rate of 89.2% in the case of no coexistence of moisture, and a NO conversion rate of 79.2% in the case of coexistence of moisture, in the selective catalytic reduction reaction with a reaction temperature no higher than 200° C., using a denitration catalyst having a content of WO₃ of 8.4 wt % and content of CuO of 3.0 wt %, when calculating content by oxide conversion of tungsten and copper.

1. A denitration catalyst comprising vanadium oxide as a main component, and a second metal, wherein content by oxide conversion of the second metal is at least 1 wt % and no more than 40 wt %, and the second metal is at least one selected from the group consisting of Co, W, Mo, Nb, Ce, Sn, Ni, Fe, Cu, Zn and Mn.

2. The denitration catalyst according to claim 1, wherein the second metal is W.

3. The denitration catalyst according to claim 1, wherein the second metal is W, and the denitration catalyst further comprises Cu as a third metal.

4. The denitration catalyst according to claim 2, comprising an oxide of a composite metal of vanadium and a second metal.

5. The denitration catalyst according to claim 1, wherein the denitration catalyst is used in denitration at 300° C. or lower.

6. The denitration catalyst according to claim 1, further comprising carbon.

7. The denitration catalyst according to claim 6, wherein carbon content is at least 0.05 wt %.

8. A method for manufacturing the denitration catalyst according to claim 1, the method comprising a step of firing a mixture of vanadate, chelate compound and a compound of the second metal.

9. The method for manufacturing according to claim 8, wherein the mixture further includes ethylene glycol.

10. The method for manufacturing according to claim 8, wherein the step of firing is a step of firing at a temperature of 270° C. or lower.
